(19) United States
(12) Patent Application Publication
(10) Pub. No.: US 2026/0171935 A1
(43) Pub. Date: Jun. 18, 2026

(54) MOTOR CONTROL DEVICE

(71) Applicants: MICROSPACE CORPORATION, Tokyo (JP); TAIYO YUDEN CO., LTD., Tokyo (JP)

(72) Inventors: Masato TANAKA, Tokyo (JP); Toranosuke UEHARA, Tokyo (JP); Hirokazu SHIRAKAWA, Tokyo (JP); Teruaki KAWAHIGASHI, Tokyo (JP)

(73) Assignees: MICROSPACE CORPORATION, Tokyo (JP); TAIYO YUDEN CO., LTD., Tokyo (JP)

(21) Appl. No.: 19/531,312

(22) Filed: Feb. 5, 2026

Related U.S. Application Data
(63) Continuation of application No. PCT/JP2024/026750, filed on Jul. 26, 2024.

(30) Foreign Application Priority Data
Aug. 7, 2023 (JP) 2023-128271

(51) Int. Cl. H02P 3/22; B60L 7/10; B60L 15/20; H02P 25/03

(52) U.S. Cl. CPC H02P 3/22; B60L 7/10; B60L 15/20; H02P 25/03

(57) ABSTRACT

A motor control device includes a drive unit including three or more half bridges for driving a brushless motor; a separation switch that opens to cut off current flowing in at least a regenerative direction between the drive unit and a power source; and a control unit executing, when an event that requires the brushless motor to be turned off is detected: a step of setting a drive output of at least some of the three or more half bridges to ground level or turning off the at least some of the three or more half bridges; a step of opening the separation switch; and a step of turning off a drive output of the remaining half bridges of the three or more half bridges whose drive outputs are not turned off during a period when power flowing to a coil included in the brushless motor is positive or zero.

### BACKGROUND OF THE INVENTION

### Technical Field

The present invention relates to a motor control technique for safely turning off a brushless motor.

### Background Art

First, the main terms used in this application will be explained.

In this application, the on/off state of a brushless motor does not refer to the presence or absence of torque or rotation. Instead, “motor on” refers to a state in which the amplifier output driving the brushless motor (hereinafter sometimes abbreviated as “motor”) is driving the motor with low impedance, while “motor off” refers to a state in which the amplifier output driving the motor is high impedance and the drive line is effectively open. While “motor on” refers to the motor's state, the same state is expressed as “drive output on” as a state of the amplifier driving the motor. Similarly, “motor off” is “drive output off” when expressed as a state of the amplifier driving the motor.

“Motor on” includes the following states: 1) powering: a state in which the directions of rotation and torque are the same; 2) coasting: a state in which torque is near zero regardless of the direction of rotation; 3) regenerative braking: a state in which the directions of rotation and torque are opposite and power is returned to the power supply; and 4) loss braking: a state in which the directions of rotation and torque are opposite and power is not returned to the power supply. On the other hand, when the motor is off, the operation is similar to the coasting described above, but when the motor is off, the amplifier output is in a high impedance state, so the current consumption and torque generated by the motor are completely zero.

In this application, “normal speed” refers to the speed at which the peak voltage of the motor's back electromotive force is equal to or less than the power supply voltage, and “overspeed” refers to the speed at which the peak voltage of the back electromotive force exceeds the power supply voltage.

In this application, “normal drive” refers to drive when the drive peak voltage command is within the power supply voltage, and “overmodulation drive” refers to drive when the drive peak voltage command exceeds the power supply voltage. Note that even if the drive peak voltage command exceeds the power supply voltage, the actual drive voltage is clipped at the power supply voltage.

Both normal drive and overmodulation drive have the motor-off state, in addition to the respective drive modes such as powering, coasting, regenerative braking, and loss braking.

Coasting drive may be used when coasting momentarily, such as during powering or regeneration. However, if cruising at zero torque continues even for a short period of time, transitioning to the motor-off state is advantageous for the following reasons. That is, 1) since no current flows through the motor coil, the generated torque can be made completely zero, 2) when coasting, the back electromotive force waveform and the drive waveform do not perfectly match (i.e., match in voltage, phase, and waveform distortion), so power running and regeneration occur momentarily, causing AC current to flow and resulting in power loss; however, this power loss can be prevented, and 3) since the generation of the drive waveform can be stopped while the motor is off, power consumption can also be stopped.

In particular, motor off may be desirable when the vehicle exceeds the normal speed limit. Specifically, even at overspeeds, the driving torque is limited to a small value up to a speed slightly higher than the upper limit of normal speed, but powering drive is possible through overmodulation driving. Furthermore, the braking torque is limited to a large value up to a speed slightly higher than the upper limit of normal speed, but regenerative braking is possible through normal driving. However, there are cases where the speed reaches a range that even overmodulation driving cannot handle. For example, for electrically assisted bicycles, although the maximum powered speed is limited by law or for safety reasons, on steep downhill slopes and the like, the vehicle may reach speeds far exceeding this limit, either naturally or through manual driving alone, even without the assist torque of the motor. In such cases, powering drive is not possible, and regenerative braking is inappropriate due to overcurrent, overtorque, overcharging, and other factors. Therefore, motor off is preferable.

However, as mentioned above, at overspeed, the peak voltage of the back electromotive force exceeds the power supply voltage. If the motor is turned off in this state, current flows into the power supply through the parasitic diodes of the half-bridge switching elements that drive the motor's coils (even in devices without parasitic diodes, the same applies if the device has a protective freewheel diode intentionally added to prevent surge voltages during switching). This causes the peak voltage of the back electromotive force to be clipped by the power supply voltage—or more precisely, the power supply voltage plus the forward voltage of the parasitic diode. This naturally causes regenerative current to flow, which in turn causes unintended regenerative braking, preventing coasting and unintended charging of the power supply.

Attempting to disconnect the power supply to cut off this regenerative current can generate a high surge voltage at the moment of disconnection, potentially damaging the disconnection switch, half-bridge switching elements, and other devices.

For example, Patent Document 1 addresses the above-mentioned problem, but only proposes a method of shorting the midpoint of a Y-connected three-phase motor to a reference potential or ground, which does not actually turn the motor off. Furthermore, compared to typical motor drive systems, this method requires additional elements and special structures (e.g., short-circuiting elements and circuits, terminals connected to the motor midpoint, etc.), which increases the system's complexity and costs.

Furthermore, Patent Document 2, for example, discloses a motor control system using an H-bridge configuration that shorts motor terminals to prevent back electromotive force from exceeding the power supply voltage. However, this brakes the motor, resulting in braking regardless of the driver's intention.

Furthermore, for example, Patent Documents 3 and 4 disclose overmodulation drive and related control, but do not consider the problems described above, nor disclose solutions to them.

### RELATED ART DOCUMENT

### Patent Document

Patent Document 1: Japanese Patent Application Laid-Open Publication No. H10-323079

Patent Document 2: Japanese Patent Application Laid-Open Publication No. 2006-262628

Patent Document 3: Japanese Patent Application Laid-Open Publication No. 2006-320039

Patent Document 4: Japanese Patent Application Laid-Open Publication No. 2021-106473

### SUMMARY OF THE INVENTION

Therefore, one object of the present invention is to provide a new motor control technology for safely turning off a brushless motor.

A motor control device according to the present invention includes: (A) a drive unit including three or more half bridges for driving a brushless motor with two or more phases; (B) a separation switch that opens to cut off current flowing in at least the regenerative direction between the drive unit and a power source; and (C) a control unit configured to execute the following steps when an event requiring the brushless motor to be turned off is detected: a first step of setting a drive output of at least some of the three or more half bridges to ground level or turning it off; a second step of opening the separation switch; and a third step of turning off a drive output of the remaining half bridges of the three or more half bridges whose drive outputs are not turned off during a period when power flowing to a coil included in the brushless motor is positive or zero.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a motor control device including: a drive unit including three or more half bridges for driving a brushless motor with two or more phases; a separation switch that opens to cut off current flowing in at least a regenerative direction between the drive unit and a power source; a control unit configured to execute the following steps when an event that requires the brushless motor to be turned off is detected: a first step of setting a drive output of at least some of the three or more half bridges to ground level or turning it off; a second step of opening the separation switch; and a third step for turning off a drive output of the remaining half bridges of the three or more half bridges whose drive outputs are not turned off during a period when power flowing to a coil included in the brushless motor is positive or zero.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a diagram showing the appearance of an electrically assisted bicycle, which is an example of an electrically assisted vehicle.

FIG. 2A is a functional block diagram of a motor control device.

FIG. 2B is a diagram illustrating an example of the configuration of a half-bridge group.

FIG. 3A is a diagram showing an example of powering drive control at normal speed.

FIG. 3B is a diagram showing an example of coasting control at normal speed.

FIG. 3C is a diagram showing an example of regenerative braking control at normal speed.

FIG. 3D is a diagram showing an example of overmodulation powering (strong powering) control at normal speed.

FIG. 3E is a diagram showing an example of overmodulation powering (weak powering) control at overspeed.

FIG. 3F is a diagram showing an example of overmodulation coasting control at overspeed.

FIG. 3G is a diagram showing an example of overmodulation regeneration (weak regeneration) control at overspeed.

FIG. 3H is a diagram showing an example of normal regeneration (strong regeneration) control at overspeed.

FIG. 4A shows an example of control in a drive output off state at normal speed.

FIG. 4B shows an example of control in a drive output off state at overspeed.

FIG. 5 is a diagram showing the problem that occurs when drive output is turned off at overspeed.

FIG. 6 is a diagram illustrating the problem that occurs when the isolation switch is opened at overspeed.

FIG. 7 is a diagram showing a control sequence performed in an embodiment of the present application.

FIG. 8 is a diagram illustrating an example of control performed in Embodiment 1.

FIG. 9 is a diagram illustrating an example of a functional configuration according to Embodiment 1.

FIG. 10 is a diagram illustrating an example of the configuration of the drive control unit according to Embodiment 1.

FIG. 11 is a diagram illustrating an example of the configuration of a drive control unit in Modification Example 1 of Embodiment 1.

FIG. 12 is a diagram illustrating an example of control performed in Modification Example of Embodiment 1.

FIG. 13 is a diagram illustrating an example of control performed in Embodiment 2.

FIG. 14 is a diagram illustrating an example of control performed in Embodiment 3.

FIGS. 15A to 15C are diagrams illustrating motor variations, with FIG. 15A showing an example of a star-type coil connection, FIG. 15B showing an example of a switching-up configuration, and FIG. 15C showing an example of a delta-type coil connection.

FIGS. 16A and 16B are diagrams illustrating variations of seven-phase motors.

FIGS. 17A to 17C are diagrams illustrating an example of a two-phase motor configuration and drive waveforms.

FIGS. 18A and 18B are diagrams illustrating an example of a two-phase motor configuration and drive waveforms.

FIGS. 19A and 19B are diagrams illustrating negative grounds and positive grounds.

### DETAILED DESCRIPTION OF EMBODIMENTS

### Embodiment 1

### [Configuration Example of Embodiment 1]

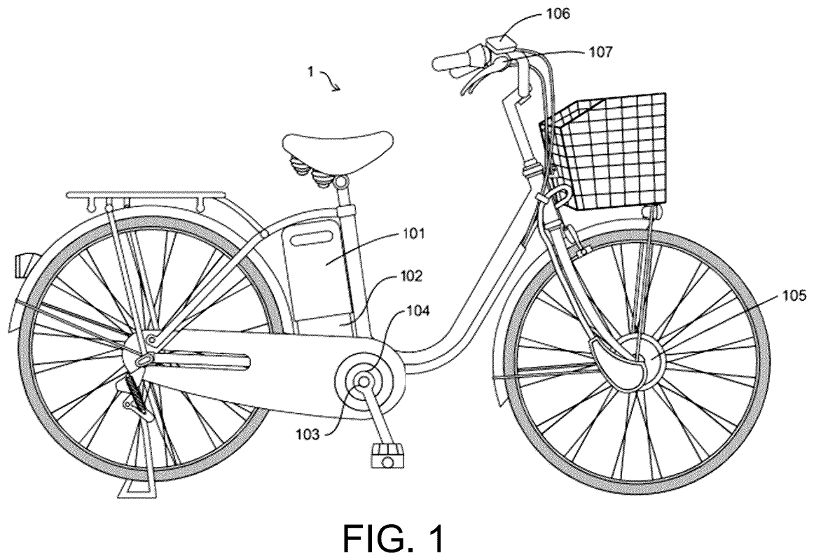

FIG. 1 is an external view of an example of an electrically assisted bicycle, which is an example of an electrically assisted vehicle according to this embodiment. This electrically assisted bicycle 1 is equipped with a motor drive unit.

The motor drive unit includes a battery pack 101, a motor control device 102, a torque sensor 103, a crank rotation sensor 104, a motor 105, a display 106, and a brake sensor 107.

The electrically assisted bicycle 1 also has a front wheel, a rear wheel, a headlight, a freewheel, a gearbox, and other components.

The battery pack 101 is, for example, a lithium-ion secondary battery, but other types of batteries, such as a lithium-ion polymer secondary battery or a nickel-metal hydride battery, may also be used. The battery pack 101 supplies power to the motor 105 via the motor control device 102 and, during regeneration, is charged by regenerated power supplied from the motor 105 via the motor control device 102.

The torque sensor 103 is located near the crankshaft and detects the user's pedaling force (i.e., input torque) and outputs this detection result to the motor control device 102. Similarly to the torque sensor 103, the crank rotation sensor 104 is located near the crankshaft and outputs a signal corresponding to the rotation of the crank to the motor control device 102.

The motor 105 is, for example, a well-known three-phase DC brushless motor, and is attached to, for example, the front wheel of the electrically assisted bicycle 1. The motor 105 rotates the front wheel, and its rotor is connected to the front wheel so that it rotates in response to the rotation of the front wheel. Furthermore, the motor 105 is equipped with a rotation sensor such as a Hall element and outputs rotor rotation information (e.g., a Hall signal) to the motor control device 102.

The motor control device 102 performs predetermined calculations based on signals from the rotation sensor of the motor 105, torque sensor 103, crank rotation sensor 104 and the like to control the drive of the motor 105 and also control regeneration by the motor 105.

The brake sensor 107 detects the user's brake operation and outputs a brake signal related to the brake operation (e.g., a signal indicating whether or not the brake is being operated) to the motor control device 102. Specifically, it is a sensor using a magnet and a reed switch.

The display 106, also known as an operation panel, typically includes a button for turning the lights on and off, a button for turning the power on and off, an LCD display, and an LED (light-emitting diode) for indicating the assist mode status.

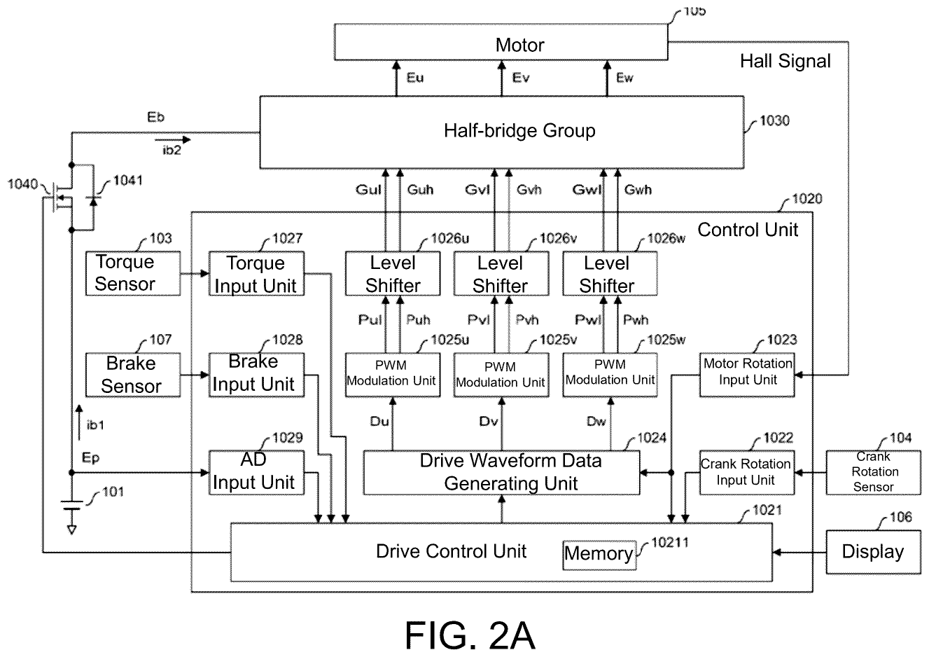

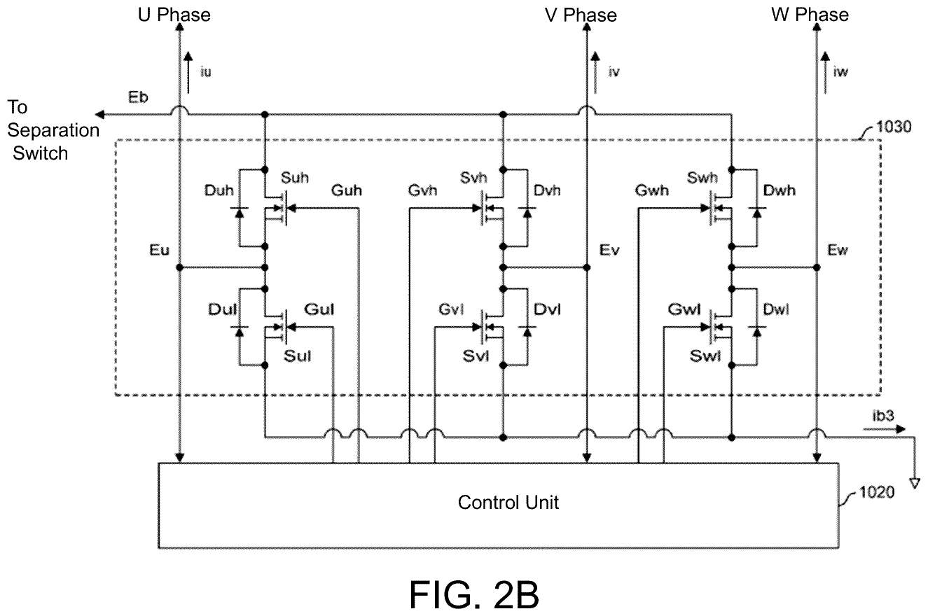

The configuration related to the motor control device 102 according to this embodiment is shown in FIGS. 2A and 2B. The motor control device 102 includes a half-bridge group 1030, a control unit 1020, and a separation switch 1040 for separating the battery included in the battery pack 101 from the half-bridge group 1030.

As shown in FIG. 2B, the half-bridge group 1030 includes, for example, three half bridges. Specifically, the half-bridge group 1030 includes a high-side switch Suh and a low-side switch Sul for the U phase, a high-side switch Svh and a low-side switch Svl for the V phase, and a high-side switch Swh and a low-side switch Swl for the W phase. Here, each switch is an N-channel field effect transistor (FET), and each FET is provided with a parasitic diode Duh, Dul, Dvh, Dvl, Dwh, or Dwl.

As will be described in detail later with reference to FIG. 2A and the like, the control unit 1020 outputs a gate signal Guh to the high-side switch Suh, a gate signal Gul to the low-side switch Sul, a gate signal Gvh to the high-side switch Svh, a gate signal Gvl to the low-side switch Svl, a gate signal Gwh to the high-side switch Swh, and a gate signal Gwl to the low-side switch Swl, thereby opening or closing each switch.

The voltage Eu at the connection point between the high-side switch Suh and the low-side switch Sul is outputted to the motor 105 as a U-phase drive output, the voltage Ev at the connection point between the high-side switch Svh and the low-side switch Svl is outputted to the motor 105 as a V-phase drive output, and the voltage Ew at the connection point between the high-side switch Swh and the low-side switch Swl is outputted to the motor 105 as a W-phase drive output.

Returning to the explanation of FIG. 2A, the separation switch 1040 is, for example, an N-channel FET, and is equipped with a parasitic diode 1041. When opened, this separation switch 1040 at least blocks the regenerative current flowing from the half-bridge group 1030 to the battery in the battery pack 101. Note that a switch that can also block the current from the battery in the battery pack 101 to the half-bridge group 1030 may also be used.

Note that the voltage on the half-bridge group 1030 side of the separation switch 1040 is represented as Eb, and the output voltage of the battery in the battery pack 101 is represented as Ep. Since the current i sw flowing through the separation switch 1040 satisfies the equation i b1=i b2=i b3, either may be measured, and it is sufficient to measure the current that is easiest to measure. For example, i b3 may be measured. Note that in the following explanation, the direction of current i sw flowing toward the half-bridge group 1030 is considered positive, and the direction of current i sw flowing toward the battery is considered negative.

Furthermore, the control unit 1020 includes a drive control unit 1021, a crank rotation input unit 1022, a motor rotation input unit 1023, a drive waveform data generating unit 1024, a PWM (Pulse Width Modulation) modulation unit 1025 (specifically, 1025u, 1025v, and 1025w), a level shifter 1026 (specifically, 1026u, 1026v, and 1026w), a torque input unit 1027, a brake input unit 1028, and an AD (Analog-Digital) input unit 1029.

The drive control unit 1021 performs predetermined calculations using input from the display 106 (e.g., power on/off), input from the crank rotation input unit 1022, input from the motor rotation input unit 1023, input from the torque input unit 1027, input from the brake input unit 1028, and input from the AD input unit 1029, and outputs the result to the drive waveform data generating unit 1024. The drive control unit 1021 also includes a memory 10211, which stores various types of data used in the calculations and data currently being processed. Furthermore, the drive control unit 1021 may be implemented by a processor executing a program, in which case the program may be stored in the memory 10211. The memory 10211 may also be provided separately from the drive control unit 1021.

The crank rotation input unit 1022 digitizes the crank rotation phase angle (which may include a signal indicating the direction of rotation) from the crank rotation sensor 104 and outputs it to the drive control unit 1021. The motor rotation input unit 1023 digitizes a signal (e.g., rotation phase angle, rotation speed, rotation direction, and the like) related to the rotation of the motor 105 (in this embodiment, the rotation of the front wheel) from the Hall signal outputted by the motor 105 and outputs it to the drive control unit 1021.

The torque input unit 1027 digitizes a signal corresponding to the pedal force from the torque sensor 103 and outputs it to the drive control unit 1021. The brake input unit 1028 digitizes a signal indicating whether the brake is being applied from the brake sensor 107 and outputs it to the drive control unit 1021. The AD input unit 1029 digitizes the output voltage from the battery of the battery pack 101 and outputs it to the drive control unit 1021.

The drive control unit 1021 determines, for example, the envelope voltage of the sinusoidal drive voltage, based on the current speed obtained from the various inputs and rotation information of the motor 105, as well as the duty ratio and lead angle for PWM modulation, and outputs these to the drive waveform data generating unit 1024. The drive waveform data generating unit 1024 generates reference drive waveform data for each of the UVW phases based on the current phase of the motor 105, and further generates drive voltage waveform data Du, Dv, and Dw by multiplying the reference drive waveform and the envelope voltage, and outputs these to the corresponding PWM modulation units 1025u, 1025v, and 1025w, respectively. Details of the drive control unit 1021 will be described later; it also controls the opening and closing of the separation switch 1040 at appropriate timing.

The PWM modulation unit 1025u generates high-frequency switching pulse trains Puh and Pul having a duty ratio corresponding to the drive voltage waveform data Du and outputs them to the level shifter 1026u. The PWM modulation unit 1025v generates high-frequency switching pulse trains Pvh and Pvl having a duty ratio corresponding to the drive voltage waveform data Dv and outputs them to the level shifter 1026v. The PWM modulation unit 1025w generates switching pulse trains Pwh and Pwl having a duty ratio corresponding to the drive voltage waveform data Dw and outputs them to the level shifter 1026w.

The level shifter 1026u converts the switching pulse trains Puh and Pul, for example, at low-voltage logic levels, into gate signals Guh and Gul having appropriate amplitudes based on the source potentials of the high-side switch Suh and the low-side switch Sul in the U-phase half bridge. Similarly, the level shifter 1026v converts the switching pulse trains Pvh and Pvl into gate signals Gvh and Gvl having appropriate amplitudes based on the source potentials of the high-side switch Svh and low-side switch Svl in the V-phase half bridge. Similarly, the level shifter 1026w converts the switching pulse trains Pwh and Pwl into gate signals Gwh and Gwl having appropriate amplitudes based on the source potentials of the high-side switch Swh and low-side switch Swl in the W-phase half bridge.

i u represents the current flowing through the U-phase coil of the motor 105, i v represents the current flowing through the V-phase coil of the motor 105, and i w represents the current flowing through the W-phase coil of the motor 105. In the following description, the direction of current flowing from the half bridge toward the coil is considered positive.

In this embodiment, a detailed description is given of a three-phase star-connected brushless motor driven by a two-wire modulated three-phase sine wave drive system using a negative ground circuit. However, the present invention is not limited to this example, and other application examples will be described later.

### [Example of Powering Control at Normal Speed]

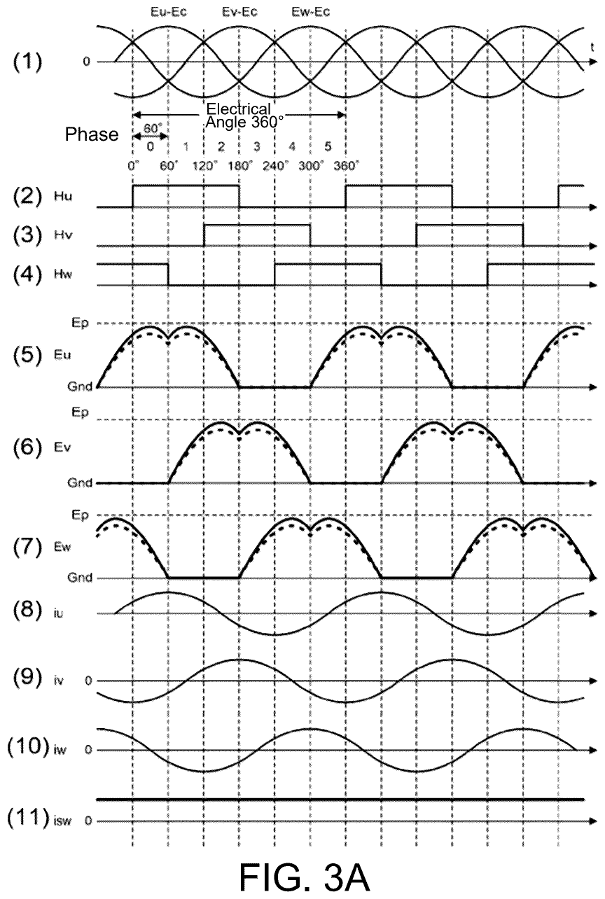

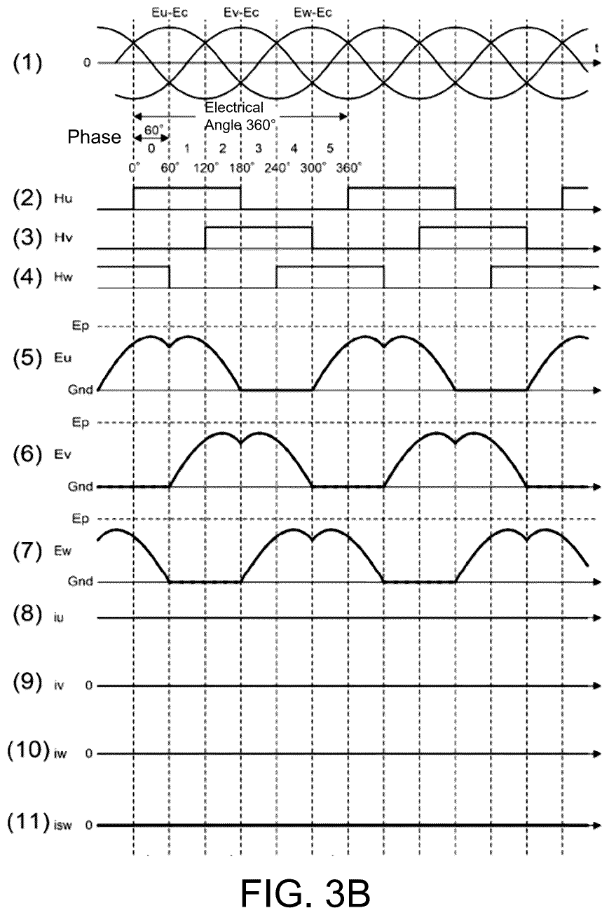

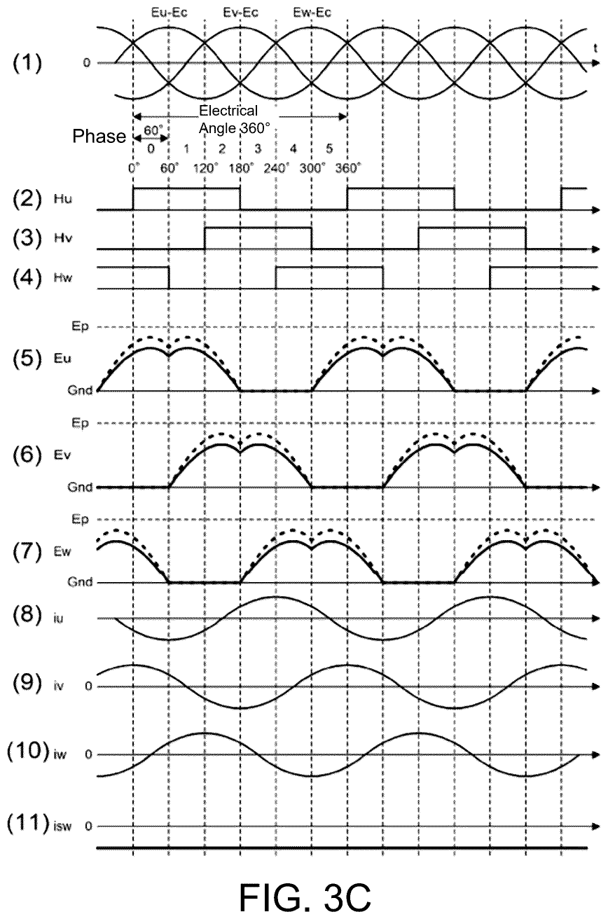

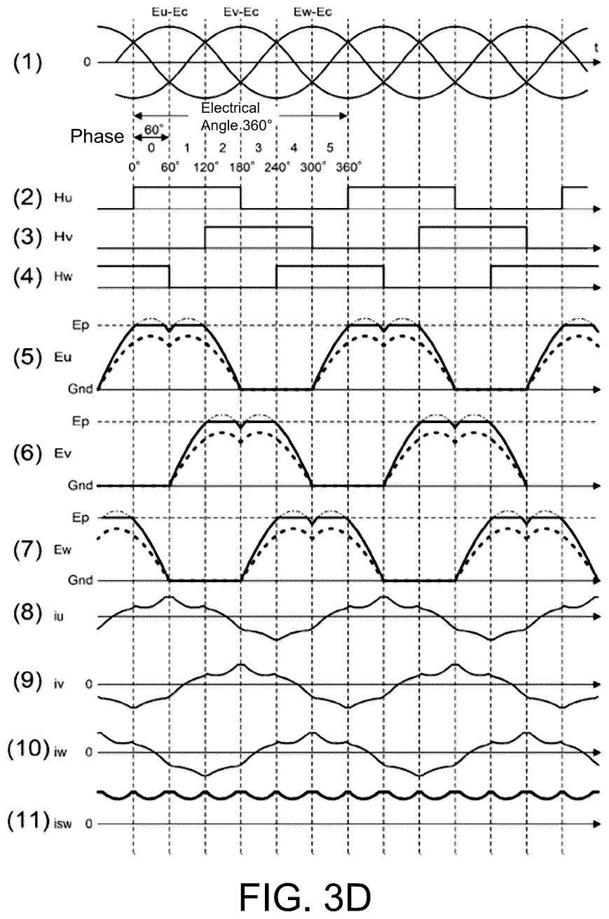

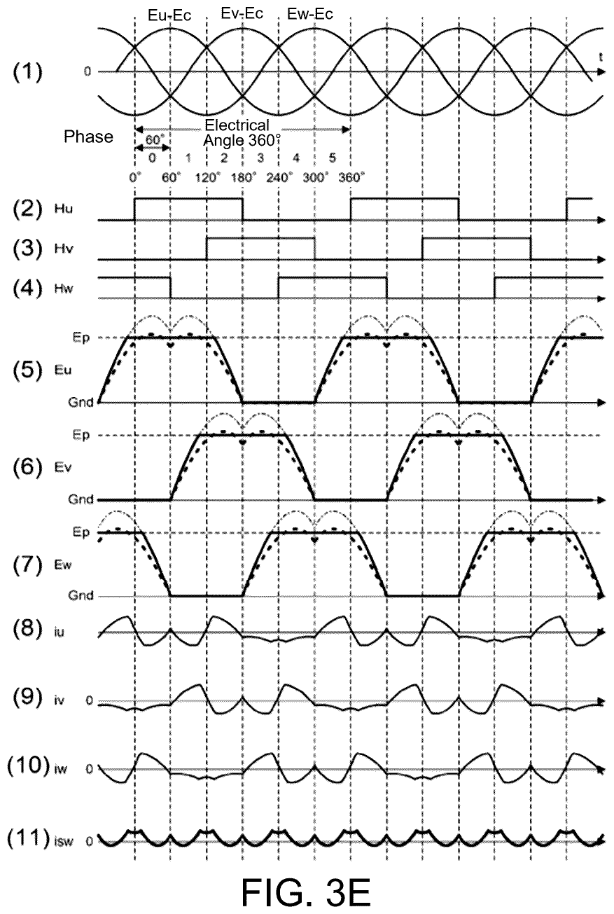

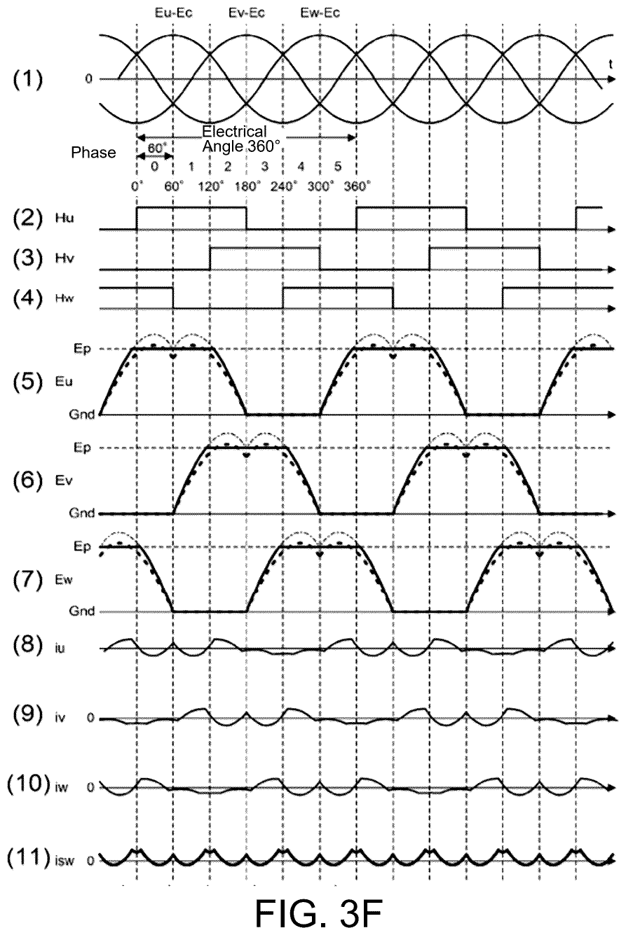

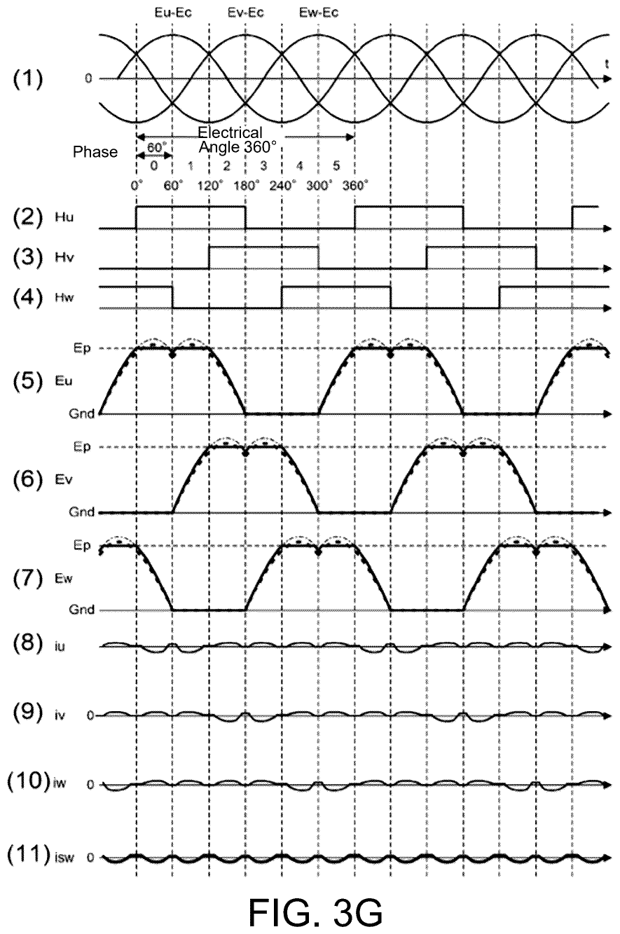

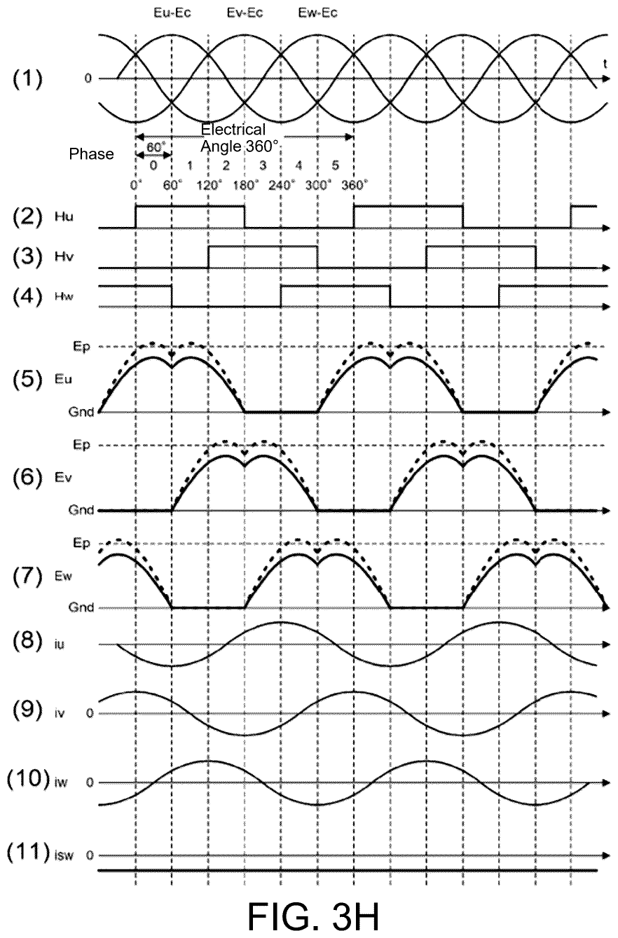

FIG. 3A illustrates the voltage and current waveforms of respective components during powering drive when traveling at a speed where the peak voltage of the back electromotive force generated in the coils of the motor 105 is equal to or less than the battery voltage (also referred to as the power supply voltage) of the battery pack 101.

FIG. 3A illustrates (1) the back electromotive force generated in each coil of the motor 105. Using the terminal voltages Eu, Ev, and Ew at the output terminals of the half-bridge group 1030 described above, and the voltage Ec at the point where all coils of the motor 105 are connected in a star-connected configuration, the voltage representing the back electromotive force of the U phase is expressed as Eu-Ec, the voltage representing the back electromotive force of the V phase is expressed as Ev-Ec, and the voltage representing the back electromotive force of the W phase is expressed as Ew-Ec. (2) represents the U-phase Hall signal Hu from the motor 105, (3) represents the V-phase Hall signal Hv from the motor 105, and (4) represents the W-phase Hall signal Hw from the motor 105.

(5) represents the U-phase drive voltage Eu (with respect to ground Gnd) and back-electromotive force (with respect to ground Gnd) of the half-bridge group 1030, respectively, using a solid line and a dashed line. (6) represents the V-phase drive voltage Ev (with respect to ground Gnd) and back-electromotive force (with respect to ground Gnd) of the half-bridge group 1030, respectively, using a solid line and a dashed line. (7) represents the W-phase drive voltage Ew (with respect to ground Gnd) and back-electromotive force (with respect to ground Gnd) of the half-bridge group 1030, respectively, using a solid line and a dashed line.

As shown in FIG. 3A, the drive voltage and back electromotive force are not sinusoidal waves, but rather alternate between a two-peak waveform period (240°) and a ground level period (120°). This is called two-line modulation three-phase sinusoidal wave drive, and is commonly used to improve power supply voltage utilization efficiency and reduce PWM modulation switching power loss by one-third compared to direct three-phase drive with sinusoidal waves. The potential difference between each of the three coils has only two degrees of freedom: the relative voltage with respect to one terminal. This makes use of the fact that the relative voltage must maintain a three-phase sinusoidal wave regardless of the absolute potential or how it changes. This is achieved by shifting the lowest potential of the three waveforms shown in (1) to ground level.

Because the drive voltage is fixed at ground level every 120° for each of the three phases sequentially, the back electromotive force (dashed line) during drive also alternates between the two-peak waveform period of 240° and the ground level period of 120°.

Note that “the power supply voltage Ep>peak voltage of the drive voltages (Eu, Ev, Ew)>peak voltage of the back electromotive force” is satisfied.

Furthermore, (8) represents the current i u flowing through the U-phase coil, (9) represents the current i v flowing through the V-phase coil, and (10) represents the current i w flowing through the W-phase coil, respectively. When the peak voltage of the drive voltage is greater than the peak voltage of the back electromotive force, a current in phase with the back electromotive force flows through each coil of the motor 105, causing the output power of the motor 105 to become positive and enter a powering state.

Furthermore, (11) represents the current i sw flowing through the separation switch 1040, i.e., the current supplied from the battery of the battery pack 101 to the motor 105. Since the motor 105 is in a powering state, the current from the battery of the battery pack 101 to the motor 105 is a positive current, resulting in power consumption.

By controlling the circuit shown in FIGS. 2A and 2B to generate waveforms such as those shown in (5) through (7) of FIG. 3A, powering at normal speed becomes possible.

### [Example of Coasting Control at Normal Speed]

FIG. 3B illustrates the voltage and current waveforms of respective components during coasting when traveling at a speed where the peak voltage of the back electromotive force generated in the coils of the motor 105 is equal to or less than the battery voltage (also called the power supply voltage) of the battery pack 101. Note that the waveform types represented by (1) through (11) are the same as those in FIG. 3A.

Waveforms (5) through (11) differ from those in FIG. 3A. In (5) through (7), the back electromotive force and the drive voltage are equal for each phase. Because the two match, the solid and dashed lines are indistinguishable in FIG. 3B. In this way, as shown in (8) through (10), the current flowing through the coils of the motor 105 is zero for each phase, and the output power of the motor 105 is also zero, i.e., the average torque is zero, resulting in a coasting state. Furthermore, since the current flowing through the motor 105 is also zero, the current i sw flowing through the separation switch 1040 is also zero, as shown in (11).

By controlling the circuits shown in FIGS. 2A and 2B to generate waveforms such as those shown in (5) through (7) in FIG. 3B, coasting at normal speed becomes possible.

### [Example of Regenerative Braking Control at Normal Speed]

FIG. 3C illustrates the voltage and current waveforms of respective components when regenerative braking is performed while traveling at a speed where the peak voltage of the back electromotive force generated in the coils of the motor 105 is equal to or less than the battery voltage (also referred to as the power supply voltage) of the battery pack 101. Note that the waveform types represented by (1) through (11) are the same as those in FIG. 3A.

Waveforms (5) through (11) differ from those in FIG. 3A. In (5) through (7), for each phase, the drive voltage (solid line) is smaller than the back electromotive force (dashed line) during the period of the two-peak waveform, and “the peak voltage of the drive voltage<the peak voltage of the back electromotive force<the power supply voltage Ep” is satisfied. When such a drive voltage is outputted, a drive current of opposite phase to the drive voltage flows, as shown in (8) through (10). As a result, the output power of the motor 105 becomes negative, resulting in a regenerative braking state. Furthermore, as shown in (11), the current i sw flowing through the separation switch 1040 becomes negative, i.e., flows from the motor 105 to the battery pack 101, thereby charging the battery of the battery pack 101.

By controlling the circuits shown in FIGS. 2A and 2B to generate waveforms such as those shown in (5) through (7) of FIG. 3C, regenerative braking at normal speed becomes possible.

[Example of Control of Overmodulation Powering (Strong Powering) at Normal Speed]

When traveling at a speed where the peak voltage of the back electromotive force generated in the coils of the motor 105 is equal to or less than the battery voltage (also called the power supply voltage) of the battery pack 101, the peak voltage of the drive voltage command value may be set to be equal to or greater than not only the peak voltage of the back electromotive force but also the power supply voltage Ep in order to increase the output power of the motor 105. The voltage or current waveforms of respective components in this case are described using FIG. 3D. The types of waveforms represented by (1) through (11) are the same as those in FIG. 3A.

Waveforms (5) through (11) differ from those in FIG. 3A. In (5) through (7), the two-peak waveform, the upper portion of which is represented by a dashed-dotted line, represents the command value of the drive voltage. Although the portion represented by the dashed-dotted line exceeds the power supply voltage Ep, the drive voltage is clipped at the power supply voltage Ep, causing the drive voltage represented by the solid line to be outputted. Note that the peak voltage of the back electromotive force is lower than the actual drive voltage and the peak voltage at its command value.

Such drive voltage represented by the solid line is at least partially higher than the drive voltage for normal powering shown in FIG. 3A. Therefore, although the waveform is distorted as shown in (8) through (10), a large drive current in phase with the drive voltage flows. This results in a powering state with higher output.

Furthermore, as shown in (11), the current i sw flowing through the separation switch 1040 contains some AC ripple components, but the DC component is significantly positive, resulting in large power consumption.

By controlling the circuits shown in FIGS. 2A and 2B to generate waveforms such as those shown in (5) through (7) in FIG. 3D, strong powering at normal speed becomes possible.

### [Control Example of Overmodulation Powering (Weak Powering) at Overspeed]

The voltage and current waveforms of respective components during powering when traveling at a speed where the peak voltage of the back electromotive force generated in the coils included in the motor 105 exceeds the battery voltage (also called the power supply voltage) of the battery pack 101 are explained using FIG. 3E.

Waveforms (5) through (11) differ from those in FIG. 3A. In (5) through (7), the two-peak waveform, the upper portion of which is represented by a dashed-dotted line, is the drive voltage command value. While the portion represented by the dashed-dotted line exceeds the power supply voltage Ep, the drive voltage is clipped at the power supply voltage Ep, causing the drive voltage represented by the solid line to be outputted where the upper portion is flat at voltage Ep. Note that the peak voltage of the back electromotive force exceeds the power supply voltage Ep but is lower than the peak voltage of the drive voltage command value.

When driven by such a drive voltage, as shown in (8) through (10), a current in phase with the drive voltage can flow despite the current waveform being distorted, which results in a powering state. Furthermore, as shown in (11), the current is flowing through the separation switch 1040 contains an AC ripple component and a positive DC component, resulting in the motor 105 consuming power.

However, if the speed exceeds the overspeed and the peak voltage of the back electromotive force is much greater than the power supply voltage Ep, the vehicle cannot enter a powering state.

By controlling the circuits shown in FIGS. 2A and 2B to generate waveforms such as those shown in (5) through (7) of FIG. 3E, weak powering at overspeed becomes possible.

### [Example of Control of Overmodulation Coasting at Overspeed]

The voltage and current waveforms of respective components during coasting when traveling at a speed where the peak voltage (dotted line) of the back electromotive force generated in the coils of the motor 105 exceeds the battery voltage (also called the power supply voltage) of the battery pack 101 are explained using FIG. 3F. Waveforms (5) through (11) differ from those in FIG. 3A.

At overspeed, coasting does not occur when the peak voltage of the drive voltage command value is equal to the peak voltage of the back electromotive force (dotted line), as is the case at normal speed. This is because the drive output voltage is limited by the power supply voltage Ep. When the peak voltage of the drive output and the peak voltage of the back electromotive force are equal, a distorted, out-of-phase current flows, resulting in weak regenerative braking.

For this reason, as shown in (5) through (7), a drive voltage command value slightly greater than the peak voltage of the back electromotive force (the solid line represents a portion equal to or smaller than the power supply voltage Ep, and the dashed-dotted line represents a portion above the voltage Ep) is given so that the actual drive voltage is clipped at the power supply voltage Ep. Then, as shown in (8) through (10), the current waveform is distorted and harmonic current flows, but the time-averaged output power, which is the product of the drive voltage and the drive current, is set to zero. This allows coasting to occur.

As shown in (11), the current i sw flowing through the separation switch 1040 contains an AC ripple component, and the DC component is slightly positive due to the resulting heat loss. Therefore, even in coasting state, a small amount of power is consumed.

By controlling the circuits shown in FIGS. 2A and 2B to generate waveforms such as those shown in (5) through (7) of FIG. 3F, coasting at overspeed becomes possible.

### [Example of Control of Overmodulation Regeneration (Weak Regeneration) at Overspeed]

The voltage and current waveforms of respective components when regenerative braking is performed while traveling at a speed where the peak voltage of the back electromotive force generated in the coils of the motor 105 exceeds the battery voltage (also referred to as the power supply voltage) of the battery pack 101 are explained using FIG. 3G. Waveforms (5) through (11) differ from those in FIG. 3A.

At overspeed, as shown in (5) through (7), a drive voltage command value lower than that of the coasting state shown in FIG. 3F (the solid line represents a portion equal to or smaller than the power supply voltage Ep, and the dashed line represents a portion above the voltage Ep) is given so that the actual drive voltage is clipped at the power supply voltage Ep. As in FIG. 3F, the peak voltage of the drive voltage command value is set higher than the peak voltage of the back electromotive force. As a result, as shown in (8) through (10), a current of opposite phase to the drive voltage flows, despite the current waveform being distorted, resulting in a weaker regenerative braking state.

Then, as shown in (11), the current i sw flowing through the separation switch 1040 contains an AC ripple component, and the DC component is negative, causing the battery to be charged.

By controlling the circuits shown in FIGS. 2A and 2B to generate waveforms such as those shown in (5) through (7) of FIG. 3G, weak regenerative braking at overspeed becomes possible.

### [Example of Control of Normal Regeneration (Strong Regeneration) at Overspeed]

FIG. 3H illustrates the voltage and current waveforms of various components when strong regenerative braking is performed when traveling at a speed where the peak voltage of the back electromotive force generated in the coils of the motor 105 exceeds the battery voltage (also referred to as the power supply voltage) of the battery pack 101. Waveforms (5) through (11) differ from those in FIG. 3A.

Similar to regenerative braking at normal speed, by lowering the peak voltage of the drive voltage below the power supply voltage Ep and the peak voltage of the back electromotive force (dotted lines) as shown in (5) through (7), a larger current can flow in the opposite phase to the drive voltage, as shown in (8) through (10).

As a result, as shown in (11), the current i sw flowing through the separation switch 1040 contains only negative DC components, allowing a large amount of power to be charged to the power supply, achieving strong regenerative braking.

By controlling the circuits shown in FIGS. 2A and 2B to generate waveforms such as those shown in (5) through (7) of FIG. 3H, strong regenerative braking at overspeed becomes possible.

Note that the back electromotive force waveforms, drive voltage waveforms, and resulting current waveforms in the coils of the motor 105 and the separation switch 1040 shown in FIGS. 3A to 3H have somewhat complex waveform relationships due to phase differences and frequency characteristics caused by the reactance of the L component of the coil. However, in this embodiment, the waveforms are shown as those for when the reactance component is sufficiently small for ease of understanding.

In practice, a phase difference is created between the drive voltage waveform and the back electromotive force waveform by applying a lead angle to the drive voltage based on the reactance component, ensuring a zero phase difference between the fundamental wave of the current flowing through the coil and the back electromotive force. Furthermore, the coil current waveform also undergoes a low-pass filter (LPF) effect due to the reactance, reducing high frequencies, distortion (i.e., harmonics), and loss due to AC current, but the final operation will be as described above.

### [Utilizing the Motor-Off State]

In addition to coasting, which results in zero torque by applying an appropriate drive voltage according to the relevant rotational speed, as shown in FIGS. 3B and 3F, another method to achieve coasting is through the motor-off state where the drive amplifier (e.g., half bridge, level shifter, and PWM modulation section) is completely disconnected from the coils of the motor 105 so that no current flows through the coils, resulting in zero torque and zero output power.

In coasting driving shown in FIGS. 3B and 3F, even if the average torque is zero, AC torque and AC current are momentarily generated due to distortion of the drive voltage waveform and back electromotive force, fluctuations in the phase difference, and other factors, resulting in some power loss. However, using the motor-off state can completely eliminate this loss. Therefore, if coasting continues for even a short period of time, it is preferable to actively utilize the motor-off state.

Note that the drive amplifier is disconnected by turning off the output of the drive amplifier connected to the coils of the motor 105, i.e., by turning off both the low-side switch and the high-side switch so the output enters a high-impedance state.

### [Drive Output Off at Normal Speed]

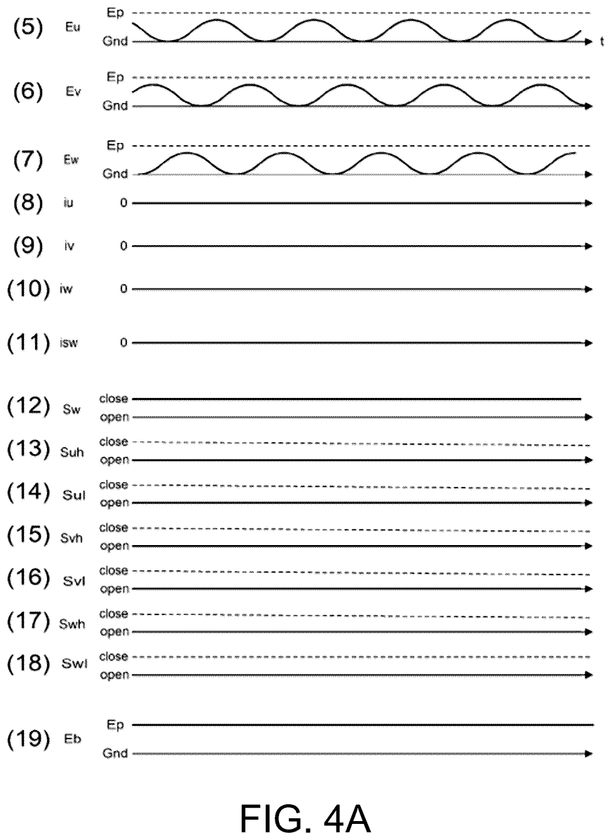

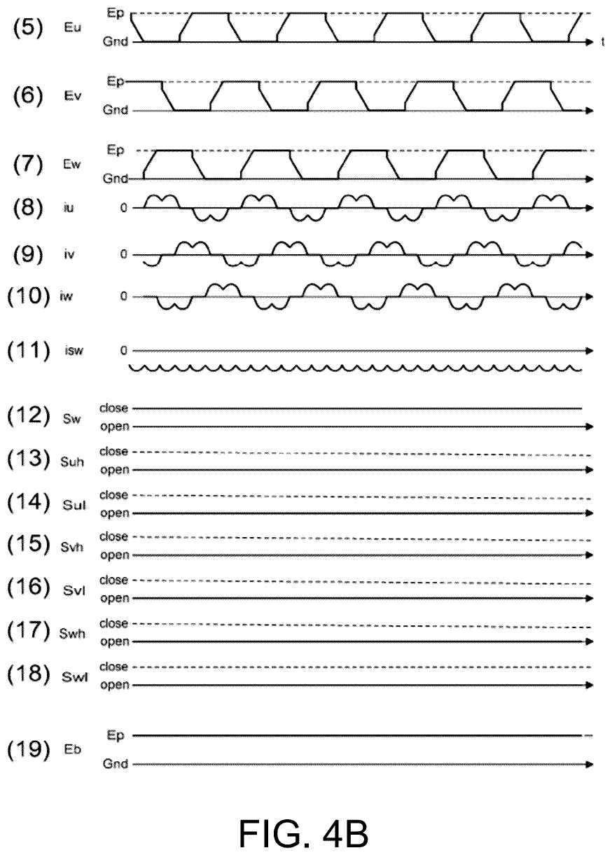

FIG. 4A shows various waveforms when the drive output is turned off at normal speed. Note that the same row numbers are used for waveforms of the same type as in FIGS. 3A through 3H, and (1) for the back electromotive force and (2) through (4) for the Hall signals are omitted.

(5) represents the drive voltage Eu of the U phase of the half-bridge group 1030. (6) represents the drive voltage Ev of the V phase of the half-bridge group 1030. (7) represents the drive voltage Ew of the W phase of the half-bridge group 1030. As shown in (5) through (7), a sine wave is formed with the lowest voltage at ground level.

(8) represents the current i u flowing through the U-phase coil, (9) represents the current i v flowing through the V-phase coil, and (10) represents the current i w flowing through the W-phase coil. Note that the direction of current flowing toward the motor 105 is considered positive. Because the drive voltages are as shown in (5) through (7), no current flows in any phase, as shown in (8) through (10).

Furthermore, (11) represents the current i sw flowing through the separation switch 1040, and (12) represents the state of the separation switch 1040 (open (off) or closed (on)).

When the drive output is turned off at normal speed, the separation switch 1040 is closed as shown in (12), and the current through the separation switch 1040 is also zero as shown in (11).

Note that (13) represents the state (open or closed) of the U-phase high-side switch Suh, (14) represents the state of the U-phase low-side switch Sul, (15) represents the state of the V-phase high-side switch Svh, (16) represents the state of the V-phase low-side switch Svl, (17) represents the state of the W-phase high-side switch Swh, and (18) represents the state of the W-phase low-side switch Swl. As mentioned above, since the drive output is off, all switches are open.

Note that (19) represents the waveform of the voltage Eb of the separation switch 1040 on the half-bridge group 1030 side. Since the separation switch 1040 is closed, it is the power supply voltage Ep.

In this way, by turning off the drive output at normal speed, i.e., by opening all switches in the half-bridge group 1030, the current flowing through the coils of each phase becomes zero, allowing for a complete coasting state.

### [Drive Output Off at Overspeed]

FIG. 4B shows various waveforms when the drive output is turned off at overspeed. Note that each row corresponds to the same waveform type as the corresponding row number in FIG. 4A.

Here, as shown in (12), when the separation switch 1040 is closed and the overspeed is reached, even if all switches in the half-bridge group 1030 are open, the back electromotive force exceeds the power supply voltage Ep and is clipped at the power supply voltage Ep, which causes a regenerative current to naturally flow from ground via the parasitic diodes of each switch.

In other words, as shown in (5) through (7), the upper limits of the voltages Eu, Ev, and Ew are clipped at the power supply voltage Ep, resulting in distorted rectangular waves. Furthermore, as shown in (8) through (10), a current naturally flows from ground to the coils of the motor 105.

Also, as shown in (11), a regenerative current containing an AC component flows through the separation switch 1040 toward the battery.

Note that (13) through (18) represent the state in which all switches in the half-bridge group 1030 are open, and (19), similar to FIG. 4A, represents a state in which the voltage Eb is equal to the power supply voltage Ep.

In this way, unintended regenerative braking occurs naturally, preventing coasting, and the regenerated power is unintentionally charged to the battery.

### [Opening of the Separation Switch 1040 at Overspeed]

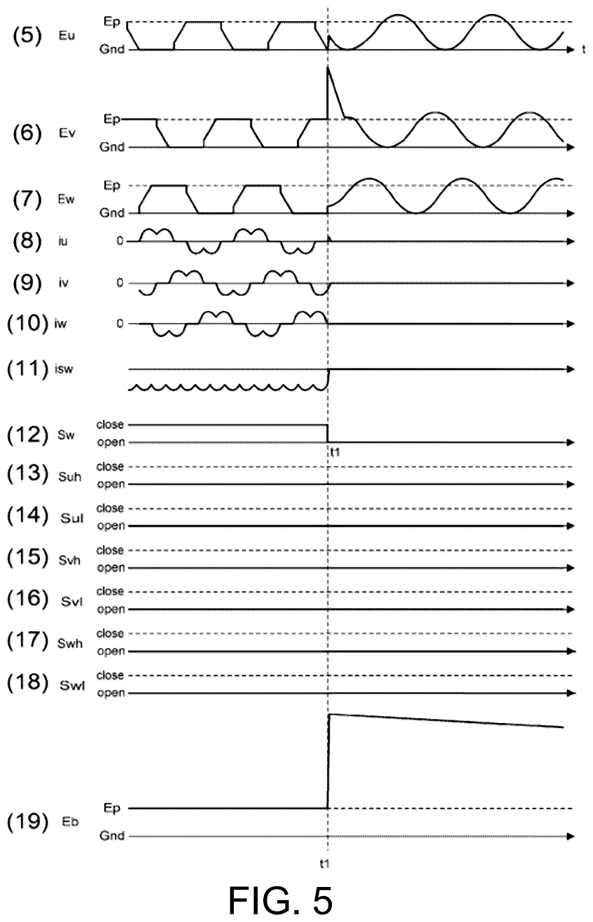

A case where the regenerative current as in FIG. 4B is shut off by opening the separation switch 1040 will be discussed. FIG. 5 shows an example of the waveform that occurs in this case. Note that each row represents the same type of waveform as the corresponding row number in FIG. 4A.

Here, as shown in (12), it is assumed that the separation switch 1040 is switched from closed to open at time t1. In this case, as shown in (11), a regenerative current is already continuously flowing through the separation switch 1040. Therefore, as soon as the separation switch 1040 opens at time t1, a high surge voltage is generated in the V phase, as shown in (6). This is charged to the stray capacitance or small-capacitance capacitor in the line from the half-bridge group 1030 to the separation switch 1040 via the parasitic diode Dvh of the V-phase high-side switch Svh. As a result, the voltage Eb of the separation switch 1040 on the half-bridge group 1030 side remains high for a while, as shown in (19).

This can damage the separation switch 1040, each switch in the half-bridge group 1030, and other peripheral devices.

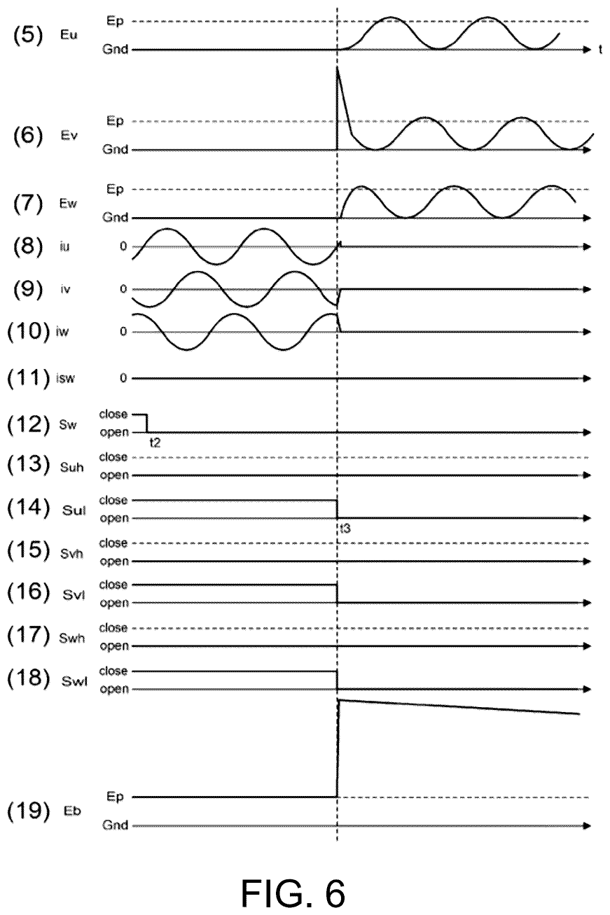

Next, a case where, while traveling at overspeed, all drive outputs of the half-bridge group 1030 are fixed to ground, the separation switch 1040 is then opened, and then all drive outputs of the half-bridge group 1030 are turned off is discussed. Examples of waveforms generated in this case are shown in FIG. 6. Note that each row represents the same type of waveform as the corresponding row number in FIG. 4A.

In this case, as shown in (13) through (18), by time t2, the low-side switches Sul, Svl, and Swl in the half-bridge group 1030 are closed, and the high-side switches Suh, Svh, and Swh are open. Then, as shown in (12), at time t3, the separation switch 1040 is switched from closed to open.

As shown in (5) through (7), until time t3, all drive outputs of the half-bridge group 1030 are fixed at ground level, so the voltages Eu, Ev, and Ew are zero. As shown in (8) through (10), the current flowing through each coil of the motor 105 is a sine wave, and even if the separation switch 1040 is opened at time t2, these waveforms do not change. That is, as shown in (11), because the current flowing through the separation switch 1040 is zero, even if the separation switch 1040 is opened at time t2, no surge occurs in any phase.

However, as shown in (13) through (18), when the remaining low-side switches Sul, Svl, and Swl are opened at time t3, a high surge voltage occurs in the V-phase voltage Ev of the motor 105 at that moment.

Before the separation switch 1040 is opened, the parasitic diodes of both the high-side and low-side switches of the half-bridge group 1030 act as voltage clips. That is, regardless of the timing at which the drive output of each phase is turned off, if the surge voltage from the coils of the motor 105 is positive, a current due to the surge voltage flows through the parasitic diode of the high-side switch, and if the surge voltage is negative, a current due to the surge voltage flows through the parasitic diode of the low-side switch. As a result, the surge voltage remains within the range from ground level to the power supply voltage Ep, preventing inadvertent high voltage generation.

However, if the separation switch 1040 is open at time t2, when the half bridge connected to the coil of the motor 105 (the V-phase half bridge in this case), through which current flows toward the battery, is opened, a high positive voltage surge is generated from the coil of the motor 105, as shown in (6). Then, a high voltage is generated on the bridge side of the separation switch 1040, as shown in (19), which still destroys the separation switch 1040, the half-bridge group 1030, and other surrounding devices.

To summarize the explanation so far, even at overspeed, the drive voltage waveform is clipped by the power supply voltage Ep until the upper limit of normal speed is slightly exceeded, allowing for small-torque powering with overmodulation drive. Even beyond that speed, regenerative braking is possible within a certain torque range. However, if the speed further increases, powering becomes impossible, and regenerative braking becomes inappropriate due to overtorque and overcurrent.

For this reason, while it is desirable to completely turn off the motor, it is not possible to safely turn off the drive output at overspeed. Specifically, turning off the drive output in the same way as the case of normal speed results in the following problems.

That is, because the back electromotive force of the motor 105 becomes higher than the power supply voltage Ep, regenerative current flows to the battery via the parasitic diodes of the switches in the half-bridge group 1030, causing unintended regenerative braking.

Furthermore, if an attempt is made to disconnect the battery using the separation switch 1040 to prevent this, a high surge voltage will be generated the moment the battery is disconnected while the regenerative current is still flowing, potentially damaging the separation switch 1040 itself, the switches in the half-bridge group 1030, and other devices. This may also cause insulation breakdown in the coil of the motor 105 itself.

As such, the motor 105 cannot be turned off once the vehicle reaches overspeed.

Furthermore, if turning off the motor is not possible, unintended braking may remain applied, resulting in unintended regenerative current overcharging the battery.

For this reason, in the past, to prevent these problems, control was implemented to stop all driving, including powering, coasting, regeneration, and loss braking, and turn off the motor 105 before overspeed is reached.

[Specific Control of this Embodiment]

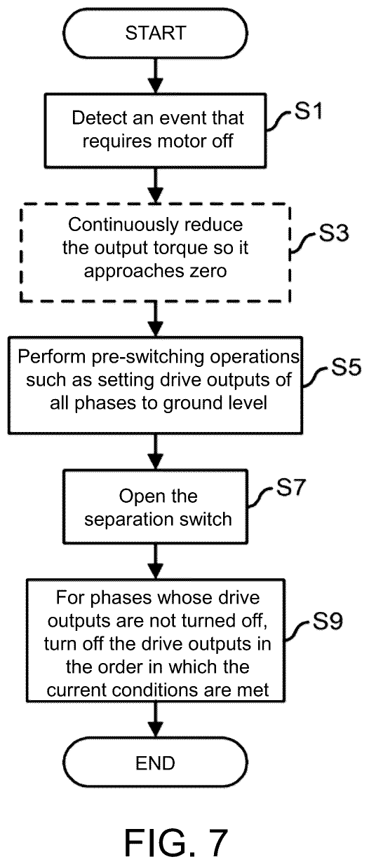

An overview of the control to be performed in this embodiment will be described using FIG. 7. First, the drive control unit 1021 of the control unit 1020 detects an event that requires motor off (step S1). This event can be defined in various ways, such as when the vehicle exceeds a predetermined speed at which powering or regenerative braking is not possible, or when the vehicle continues coasting for a certain period of time. While the above-mentioned problems are resolved when traveling at overspeed, the control shown in FIG. 7 may also be performed when traveling at normal speed.

Next, the drive control unit 1021 executes control to continuously reduce the output torque of the motor 105 so that it approaches zero (step S3). This control is optional, and is indicated by a dotted line in FIG. 7. This control is performed to prevent a sudden change from the current output torque of the motor 105 to zero torque, thereby preventing shock, since the drive output will inevitably be turned off in a later control and the torque becomes zero. In this step, it is preferable to smoothly approach zero torque. Note that the control in step S5 described below corresponds to short-circuit braking, which may generate braking torque and cause a large torque shock. However, when traveling at high speed, this series of control can be completed in a short time, and although a momentary clicking sound may occur, no large torque shock will occur.

Then, the drive control unit 1021 controls the half-bridge group 1030 to perform a pre-switching operation (step S5). There are several variations of the pre-switching operation, but in this embodiment, the drive outputs of all phases in the half-bridge group 1030 are set to ground level. That is, all high-side switches are opened and all low-side switches are closed. By performing this control, as shown in FIG. 6, the current flowing through the separation switch 1040 can be stably set to zero, preventing the occurrence of a high surge voltage.

Then, the drive control unit 1021 opens the separation switch 1040 (step S7). This separates the battery in the battery pack 101 from the half-bridge group 1030, preventing regenerative current from flowing to the battery.

Finally, the drive control unit 1021 turns off the drive output for each phase of the half-bridge group 1030 whose drive output is not turned off, in the order in which a predetermined current condition is met (step S9). If the drive output of all phases is set to ground level in step S5, the drive output of all phases is not turned off. Furthermore, in the case of a negative ground, as assumed in this embodiment, the predetermined current condition is a condition in which the current flowing through each coil included in the motor 105 is positive or zero. The drive output of the corresponding phase is turned off while this current condition is met. In this waveform example, the drive output is turned off the second time the condition is met; however, it may be turned off the first time, or the third time or later, as long as the condition is met. Furthermore, the order does not have to be U, V, and W. If the above current conditions are met simultaneously, the drive output for multiple phases may be turned off simultaneously. Furthermore, the timing at which the separation switch 1040 is opened may also coincide with the timing at which the drive output for a phase whose drive output is not turned off is turned off. This execution of turning off the drive output also applies to the embodiments described later.

Turning off the drive output while such current conditions are met can prevent high voltage surges.

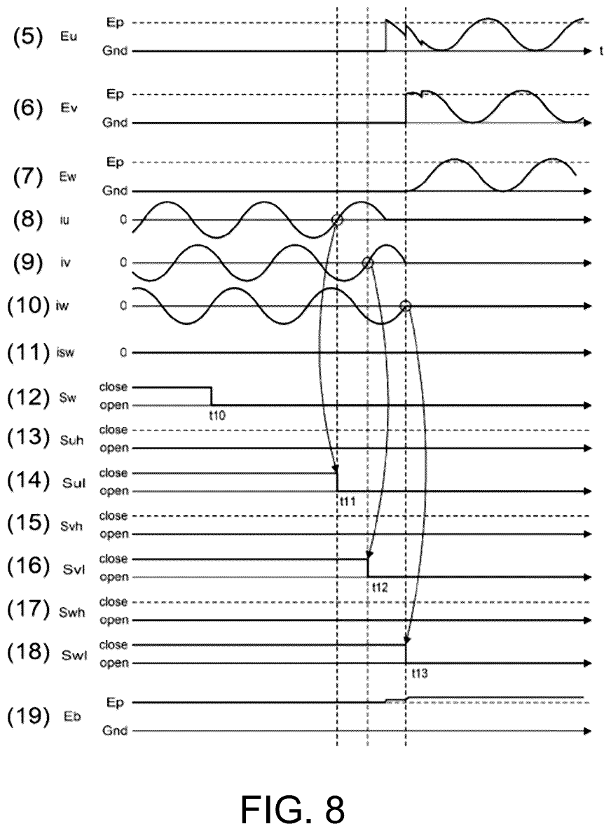

Examples of various waveforms that result from this control are described using FIG. 8. Note that each row in FIG. 8 represents the same type of waveform as the corresponding row number in FIG. 4A.

In FIG. 8, step S1 is executed long before time t10, step S3 is skipped, and the process proceeds to step S5, where the drive output for all phases in the half-bridge group 1030 is set to ground level. That is, as shown in (13) through (18), all high-side switches are open and all low-side switches are closed. Note that, because the drive outputs of all phases are set to ground level, the voltages Eu, Ev, and Ew are at ground level as shown in (5) through (7). Furthermore, the currents i u, i v, and i w flowing through the coils of the motor 105 are sinusoidal as shown in (8) through (10), but the current i sw flowing through the separation switch 1040 is zero as shown in (11).

In this embodiment, since the current i sw flowing through the separation switch 1040 is already zero, in step S7, the separation switch 1040 is changed from closed to open at time t10, which can occur at any time.

Subsequently, at time t11, when the current i u becomes positive, the U-phase low-side switch Sul is changed from closed to open. Furthermore, at time t12, when the current i v becomes positive, the V-phase low-side switch Svl is changed from closed to open. Then, at time t13, when the current i w becomes positive, the W-phase low-side switch Swl is switched from closed to open.

In this way, the current i sw flowing through the separation switch 1040 remains zero, and the voltage Eb of the separation switch 1040 on the half-bridge group 1030 side is maintained at a voltage slightly higher than the power supply voltage Ep.

Note that, as shown in (5) through (7), there are moments when the U-phase voltage Eu and the V-phase voltage Ev momentarily rise. However, this is not a surge voltage, as it does not occur at the moment the low-side switch for each phase is opened. The drive outputs for the U and V phases were turned off earlier. At this time, positive currents i u and i v flowed through the parasitic diodes on the ground side of those phases, clamping them to ground potential. However, the current in the coils of the motor 105 gradually changed, and the clamping by the parasitic diodes ended the moment the current went from positive to negative. Therefore, since this was merely a sudden appearance of a back electromotive force voltage, there is no risk of a voltage equal to or higher than the back electromotive force being generated.

In this way, even when traveling at overspeed, the current i sw flowing through the separation switch 1040 does not always flow in the negative direction (i.e., in the regenerative direction), but rather periods of positive flow and periods of zero current can be generated. This creates a timing window in which a high surge voltage is not generated even when the separation switch 1040 is opened. Then, by sequentially turning off the drive output of each phase that satisfies the current condition, no surge occurs, allowing for safe transition to the motor off state even at overspeed.

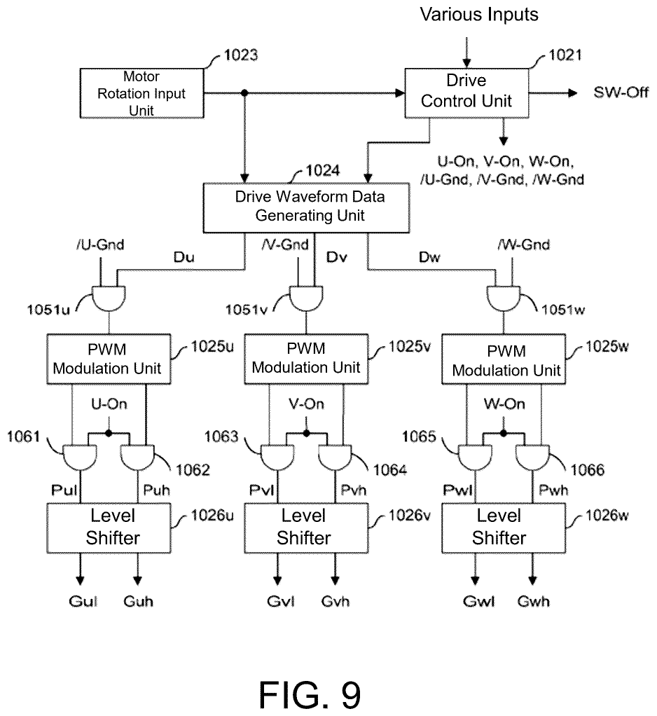

An example of the functional configuration for executing this control is described using FIG. 9. FIG. 9 is a more detailed view of the functional block diagram shown in FIG. 2A, illustrating the portion of this embodiment.

That is, in this embodiment, logical product units 1051u, 1051v, and 1051w and drive output control units 1061 to 1066, which are AND gates, are added.

The motor rotation input unit 1023 outputs information on the rotation speed and rotation phase of the motor 105 to the drive control unit 1021 and the drive waveform data generating unit 1024 in accordance with the Hall signal.

The drive control unit 1021 performs predetermined calculations based on various inputs, as described above, to determine, for example, the envelope voltage of the sinusoidal drive voltage, as well as the duty ratio and lead angle for PWM modulation, and outputs these to the drive waveform data generating unit 1024. The drive waveform data generating unit 1024 generates reference drive waveform data for each of the UVW phases according to the current phase of the motor 105, the duty ratio, and the lead angle, and further generates drive voltage waveform data Du, Dv, and Dw by multiplying the reference drive waveform and the envelope voltage, and outputs these to the corresponding PWM modulation unit 1025u, 1025v, and 1025w, respectively.

Furthermore, the drive control unit 1021 detects from various inputs an event that requires the motor to be turned off in step S1. When step S3 is executed, the drive control unit 1021 changes the output to the drive waveform data generating unit 1024 such that the output torque of the motor 105 gradually reduces to zero. The drive control unit 1021 also generates signals /U-Gnd, /V-Gnd, and /W-Gnd for the pre-switching operation in step S5. When these signals are high (1), the output of the drive waveform data generating unit 1024 is outputted directly from the logical product units 1051u, 1051v, and 1051w. When these signals are low (0), the logical product units 1051u, 1051v, and 1051w output a drive waveform with zero amplitude, and the PWM modulation unit 1025u, 1025v, and 1025w turn on the low-side switches, setting each half bridge to ground level.

Furthermore, for step S7, the drive control unit 1021 outputs a signal SW-Off to open the separation switch 1040. For example, if the signal SW-Off is high, the separation switch 1040 is closed, and if it is low, the separation switch 1040 is opened.

Furthermore, for step S9, the drive control unit 1021 generates signals U-On, V-On, and W-On to turn off the drive output during a period when the condition that the current flowing through each coil included in the motor 105 is positive or zero is satisfied. These signals are inputted to the drive output control units 1061 through 1066, respectively. When the signals are high, the drive output control units 1061 through 1066 directly output the outputs from the PWM modulation units 1025u, 1025v, and 1025w to the level shifters 1026u, 1026v, and 1026w. When the signals are low, the drive output control units 1061 through 1066 output signals to the level shifters 1026u, 1026v, and 1026w that open the switches included in the half bridges.

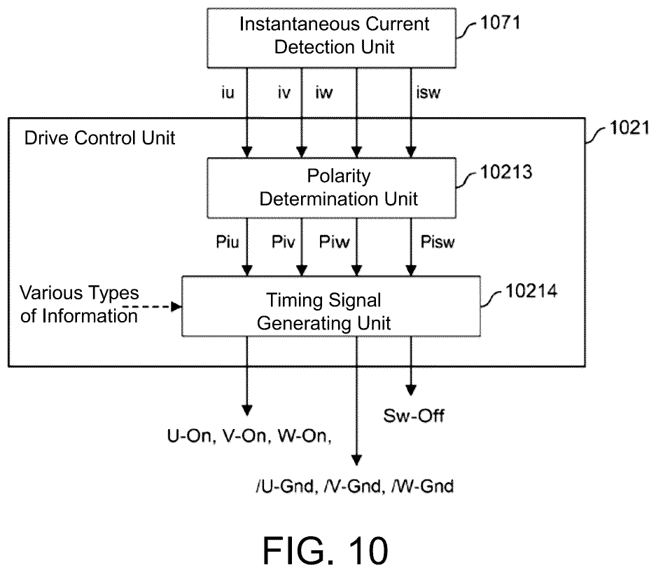

The drive control unit 1021 generates the above-mentioned signals using the configuration shown in FIG. 10. Specifically, the drive control unit 1021 includes a polarity determination unit 10213 and a timing signal generating unit 10214.

Based on the output from the instantaneous current detection unit 1071, which detects the instantaneous currents iu, iv, iw, and i sw, the polarity determination unit 10213 determines whether each instantaneous current is flowing toward the motor 105 in the case of a negative ground, or whether the current is zero or greater (positive or zero), and outputs information Piu, P iv, P iw, and P isw indicating the polarity (zero or greater or negative) of each instantaneous current to the timing signal generating unit 10214. Note that the instantaneous current detection unit 1071 may already be provided for another purpose, in which case it may be utilized.

The timing signal generating unit 10214 generates and outputs the aforementioned signals U-On, V-On, W-On, /U-Gnd, /V-Gnd, /W-Gnd, and SW-Off based on the output from the polarity determiner 10213 and various other information.

If the drive output of all phases is set to ground level in step S5, the timing signal generating unit 10214 outputs the signals /U-Gnd, /V-Gnd, and /W-Gnd at low level after step S1 or S3.

If the drive output of all phases is set to ground level in step S5, the current i sw flowing through the separation switch 1040 is always zero after step S5, so the polarity information Pisw is not used, although it may be used in other embodiments described below. In this embodiment, in step S7, the timing signal generating unit 10214 outputs the signal Sw-Off at low level at a certain timing after step S5, thereby opening the separation switch 1040.

Then, the timing signal generating unit 10214 references the polarity information Piu, Piv, and Piw, and outputs a low signal (one of U-On, V-On, or W-On) for the phase for which information indicating positive or zero is obtained.

This enables the operation shown in FIG. 7 to be executed at the correct timing.

Note that the timing signal generating unit 10214 may also generate timing signals using other types of information.

### MODIFICATION EXAMPLE 1 OF EMBODIMENT 1

In Embodiment 1, the instantaneous current was detected and the polarity of the instantaneous current was used. However, there are cases in which the instantaneous current detection unit 1071 is not provided. In such cases, rather than modifying the system to include an instantaneous current detection unit 1071, it is possible to estimate whether each current is equal to or greater than zero based on rotational phase information obtained from Hall signals from the motor 105.

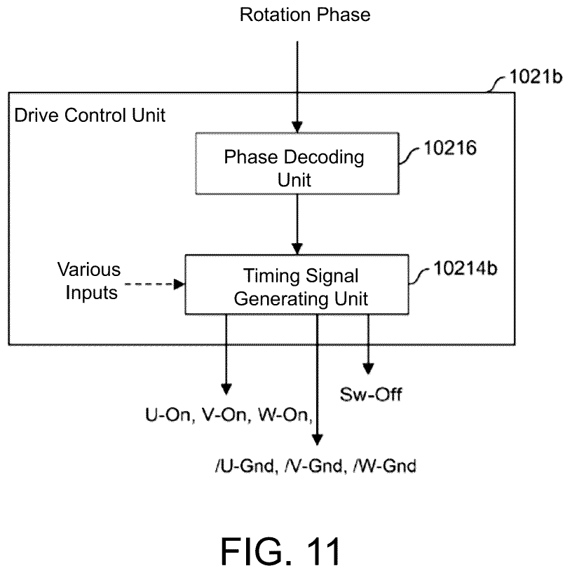

A configuration example for such a case is shown in FIG. 11. Specifically, the drive control unit 1021b includes a phase decoding unit 10216 and a timing signal generating unit 10214b.

Based on the rotational phase information of the motor 105 obtained from the motor rotation input unit 1023, the phase decoding unit 10216 determines whether the timing corresponds to a phase change timing at which the instantaneous currents i u, i v, i w, and i sw have been previously confirmed to be positive or zero in the case of a negative ground. If the timing corresponds to a previously confirmed phase change timing, the phase decoding unit 10216 outputs a corresponding signal to the timing signal generating unit 10214b.

Based on the output from the phase decoding unit 10216 and other types of information, the timing signal generating unit 10214b generates and outputs the aforementioned signals U-On, V-On, W-On, /U-Gnd, /V-Gnd, /W-Gnd, and SW-Off.

Note that if the drive output of all phases is set to ground level in step S5, the timing signal generating unit 10214b outputs the signals /U-Gnd, /V-Gnd, and /W-Gnd at low level at any timing after step S1 or S3. In this case, the current i sw flowing through the separation switch 1040 is always zero after step S5, so there is no need to specify a phase change timing at which the instantaneous current i sw is confirmed to be positive or zero.

If the drive output of all phases is set to ground level in step S5, the timing signal generating unit 10214b outputs the signal Sw-Off at low level at any timing after step S5, thereby opening the separation switch 1040.

Subsequently, in response to a notification from the phase decoding unit 10216, the timing signal generating unit 10214b outputs a low-level signal (either U-On, V-On, or W-On) for the phase related to the notification.

Note that the phase decoding unit 10216 may shift the timing using not only information about the rotational phase of the motor 105, but also information about the rotational speed and target output torque. This improves the accuracy of estimating the current direction under any operating conditions, and increases the margin for timing to open the separation switch 1040 and timing to turn off the drive output.

In this modification example, the timing chart shown in FIG. 8 slightly changes. This is shown in FIG. 12.

The process is the same as in FIG. 8 up to time t10. However, at time t21, when the phase decoding unit 10216 detects that the V-phase Hall signal Hv transitions from high to low, it notifies the timing signal generating unit 10214b, which then sets U-On to low in response to the notification. This opens the U-phase low-side switch Sul, turning off the U-phase drive output.

Subsequently, at time t22, the phase decoding unit 10216 detects a high-to-low transition of the W-phase Hall signal Hw and notifies the timing signal generating unit 10214b. In response to the notification, the timing signal generating unit 10214b sets V-On to low. This opens the V-phase low-side switch Svl, turning off the V-phase drive output.

Furthermore, at time t23, the phase decoding unit 10216 detects a high-to-low transition of the U-phase Hall signal Hu and notifies the timing signal generating unit 10214b. In response to the notification, the timing signal generating unit 10214b sets W-On to low. This opens the W-phase low-side switch Svl, turning off the W-phase drive output.

Other signal waveforms are the same as those in FIG. 8.

This arrangement allows for compatibility even in cases where the instantaneous current detection unit 1071 is not pre-installed.

### MODIFICATION EXAMPLE 2 OF EMBODIMENT 1

In Embodiment 1, the drive outputs of the corresponding phases are set to ground level using /U-Gnd, /V-Gnd, and /W-Gnd. However, since the drive control unit 1021 outputs the duty ratio for PWM modulation, setting this duty ratio to zero allows the drive outputs to be set to ground level.

Therefore, such an implementation may be adopted.

### Embodiment 2

In Embodiment 2, the drive outputs of all phases are set to ground level in step S5. However, setting the drive outputs of all phases to ground level is not the only possible pre-switching operation.

For example, the drive outputs of only some phases may be set to ground level, and the drive outputs of the remaining phases may be turned off. Alternatively, the drive outputs of the remaining phases may be left on. Furthermore, the drive outputs of some of the remaining phases may be turned off, and the drive outputs of other remaining phases may be left on.

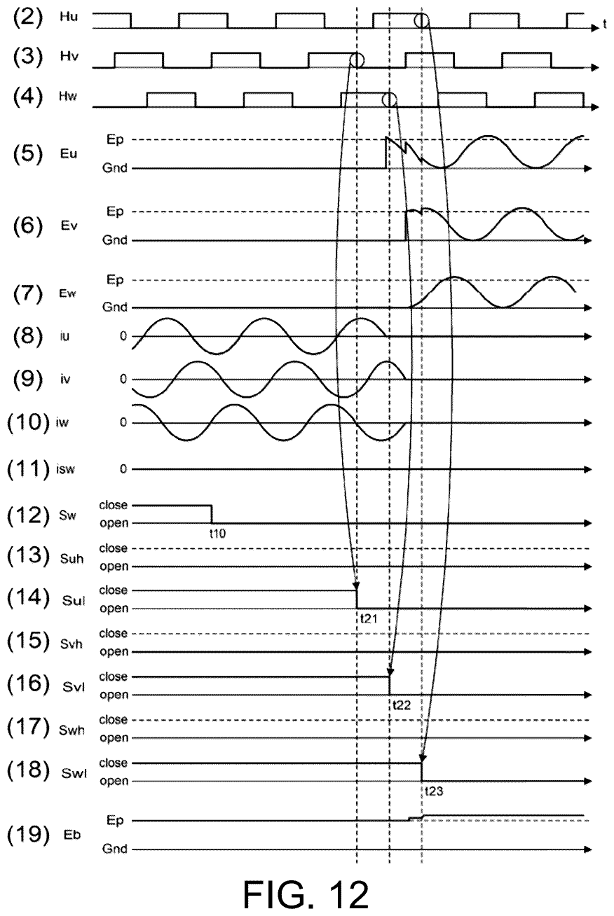

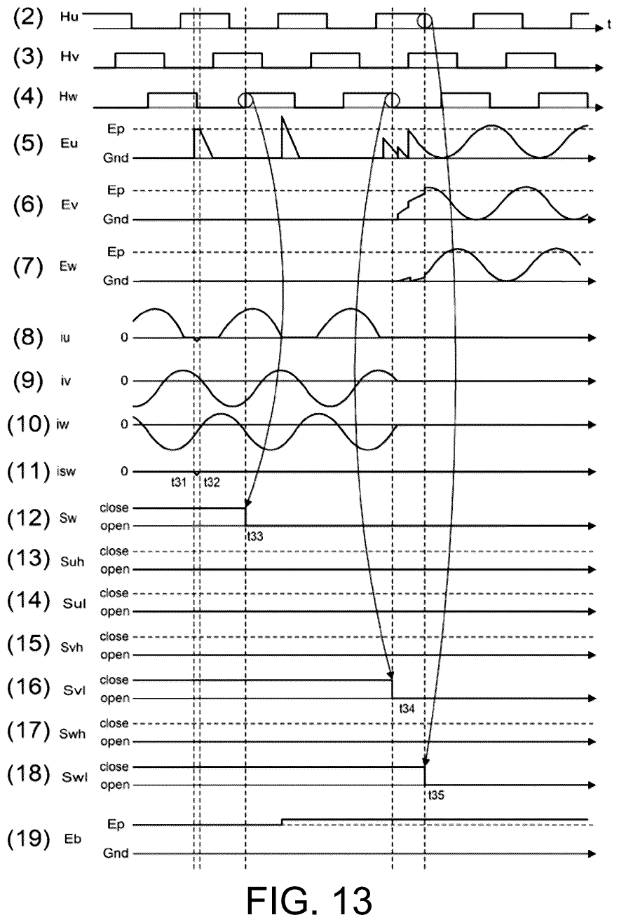

For example, FIG. 13 illustrates an example in which two phases (e.g., the V and W phases) are set to ground level in step S5, and one phase (e.g., the U phase) is turned off in step S5. While FIG. 13 illustrates an example using the phase decoding unit 10216 shown in FIG. 11, operation may be controlled based on instantaneous current if an instantaneous current detection unit 1071 is provided, as shown in FIG. 10.

In step S5, the drive output for the U phase is turned off, so the timing signal generating unit 10214b sets U-On to low and outputs it. Note that the signal /U-Gnd can remain high. On the other hand, for the W and V phases, the signals /V-Gnd and /W-Gnd are outputted as low-level signals in step S5.

If two phases (e.g., the V and W phases) are set to ground level in step S5 and one phase (e.g., the U phase) is turned off in step S5, as shown in (5), the voltage Eu has peaks around the time when the Hall signal Hw of the W phase, which is fixed at ground level, transitions from high to low. The U-phase current i u shown in (8) is not a sine wave, but rather has a waveform that is slightly negative from time t31 to t32. Accordingly, as shown in (11), the current i sw flowing through the separation switch 1040 is negative rather than zero from time t31 to t32.

In the example of FIG. 13, the timing signal generating unit 10214b sets the signal Sw-Off to low so that the separation switch 1040 is opened at time t33, when the Hall signal Hw of the W phase transitions from low to high, with the largest time margin during the period when the current i sw flowing through the separation switch 1040 is positive or zero.

After this, since the drive output for the U phase has already been turned off, the phase decoding unit 10216 detects the timing when the conditions for turning off the drive output for the V and W phases are estimated to be satisfied, i.e., in the case of a negative ground, the current to the coils of the motor 105 is zero or positive.

In this example, the phase decoding unit 10216 detects the timing when the W-phase Hall signal Hw transitions from high to low and notifies the timing signal generating unit 10214b. The phase decoding unit 10216 also detects the timing when the U-phase Hall signal Hu transitions from high to low and notifies the timing signal generating unit 10214b.

Upon receiving the notification from the phase decoding unit 10216, the timing signal generating unit 10214b outputs a low-level signal V-On at time t34, opening the V-phase low-side switch Svl and turning off the drive output. Furthermore, upon receiving the notification from the phase decoding unit 10216, the timing signal generating unit 10214b outputs a low-level signal W-On at time t35, opens the W-phase low-side switch Sw1, and turns off the drive output.

Even in such a case, no surge high voltage is generated when the separation switch 1040 is opened, and no surge high voltage is generated when the drive outputs of the V and W phases are turned off.

Note that if the drive output for the U phase is turned off in step S5, current flows toward the battery from time t31 to t32. However, since the current i u is positive or zero during other periods, the current i sw flowing through the separation switch 1040 is also zero, and thus there are many opportunities to open the separation switch 1040.

When the drive output for some phases is set to ground level in this way, the terminals of the motor 105 are shorted to ground from the perspective of the coils of the motor 105. While AC current flows through at least that phase's output, all of this current flows in and out of ground, and neither positive nor negative current flows through the separation switch 1040. As a result, the current i sw flowing through the separation switch 1040 via the phase whose drive output is set to ground level becomes zero, resulting in an imbalance between the phases. As a result, there is a period during one electrical cycle in which the current i sw flowing through the separation switch 1040 is positive or zero, rather than being steadily negative.

On the other hand, when the drive output of some phases is turned off, the AC current of the drive output of that phase, particularly the large-amplitude fundamental, hardly flows (only the amount by which the instantaneous waveform peak exceeds the power supply voltage Ep flows). This causes an imbalance between the phases, resulting in a period during one electrical cycle in which the current i sw flowing through the separation switch 1040 is positive or zero, rather than being steadily negative.

As a result of the above, even when the drive output of some phases is set to ground level and the remaining drive outputs are turned off in step S5, motor off can be achieved without generating high surge voltages.

Note that when the configuration shown in FIG. 10, which uses the instantaneous current detection unit 1071, is employed, it is also possible to detect the timing or period when the current i sw flowing through the separation switch 1040 becomes equal to or greater than zero from the instantaneous current i sw, and output a low-level Sw-Off, which is a signal that opens the separation switch 1040

Also, if in step S5 the drive output for some phases is set to ground level and the drive output for the remaining phases is left on, the signal /W-Gnd for the phases whose drive output is to stay on can be left high, and then in step S9, low-level signals (U-On, V-On, W-On) can be outputted to turn off the drive output when the current condition is satisfied.

### Embodiment 3

In this embodiment, the pre-switching operation involves turning off the drive output of some phases while keeping the drive output of the remaining phases on. That is, unlike Embodiments 1 and 2, the pre-switching operation does not involve setting the drive output of at least some phases to ground level, but rather simply turning off the drive output of some phases.

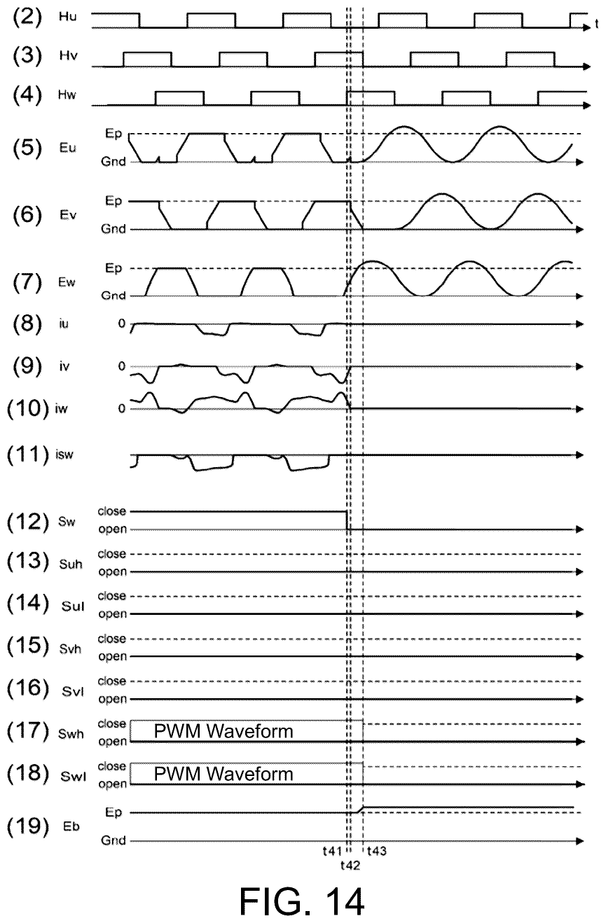

For example, FIG. 14 shows an example in which the drive output of two phases (e.g., U and W phases) is turned off in step S5, while the drive output of the remaining phase (e.g., W phase) remains on, with no special control performed in step S5. Note that prior to FIG. 14, all three phases are PWM-driven (a weak regenerative state) at overspeed.

Because PWM drive is performed at overspeed, PWM is significantly overmodulated to reduce the generated torque before turning off the motor 105. However, the torque does not reach zero, and the regeneration state transitions to the weak regeneration state shown in FIGS. 3G and 3H. The current i sw flowing through the separation switch 1040 remains constantly negative or, depending on driving conditions, may be positive for some periods.

However, if, for example, the drive outputs of the U and V phases are turned off while the W phase remains PWM-driven, prior to time t41, as shown in FIG. 14, due to imbalance between the phases and the complex behavior of the parasitic diodes, a period occurs in which the current i sw through the separation switch 1040 is positive or zero, rather than being constantly negative, as shown in (11).

In this embodiment, the separation switch 1040 is opened as shown in (12) at the timing when it is confirmed that the current i sw flowing through the separation switch 1040 has become positive or zero, or at the timing when the current i sw of the separation switch 1040 definitely becomes positive or zero by a certain combination of Hall signals, for example, which is known in advance through experiments or the like (in the example of FIG. 14, the timing when the W-phase Hall signal Hw transitions from low to high), i.e., at time t41.

Then, at time t42, when the V-phase current i v and the W-phase current i w flowing through the coils of the motor 105 become zero, the voltage waveforms shown in (5) through (7) change, and the back electromotive forces of all the UVW phases become sinusoidal waveforms clamped to the Gnd potential. Because this is an overspeed state, the peak voltage is higher than the power supply voltage. As a result, the voltage Eb of the separation switch 1040 on the motor 105 side is also higher than the power supply voltage Ep, as shown in (19). However, because this is not due to a surge in coil current, no abnormally high voltage sufficient to destroy peripheral devices is generated.

Then, at time t43, when the current i w flowing through the motor 105 becomes positive or zero, or when the current i w definitely becomes positive or zero by a certain combination of Hall signals, for example, which is known in advance through experiments or the like (in the example of FIG. 14, the timing when the V-phase Hall signal Hv transitions from low to high), the W-phase drive output is turned off by opening the high-side switch Swh and the low-side switch Swl, as shown in (17) and (18).

This makes it possible to safely achieve motor off, as in Embodiments 1 and 2.

Although the conditions for opening the separation switch 1040 were met at time t41, the W-phase current i w also meets the current condition of being positive or zero after time t41. Therefore, the W-phase drive output may also be turned off at time t41. Even in this case, only the high-side switch Swh and the low-side switch Swl are opened; other waveforms remain unchanged.

As mentioned above, if the current conditions for each phase are met in step S9 of FIG. 7, the drive output is simultaneously turned off. However, for step S7 as well, if the condition that the current i sw flowing through the separation switch 1040 is positive or zero is met, steps S7 and S9 may be executed simultaneously.

### [Other Technical Matters]

### [Regarding Motors to Which the Embodiments Can Be Applied]

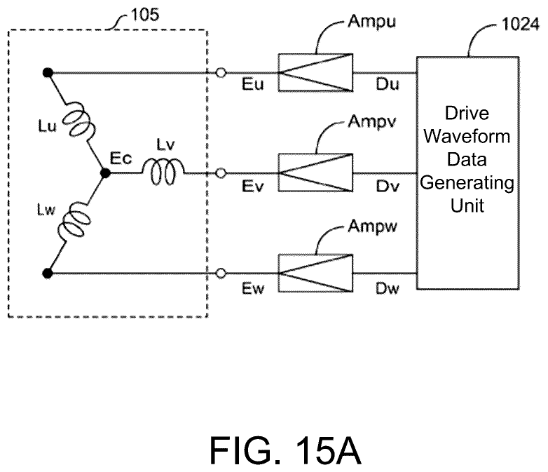

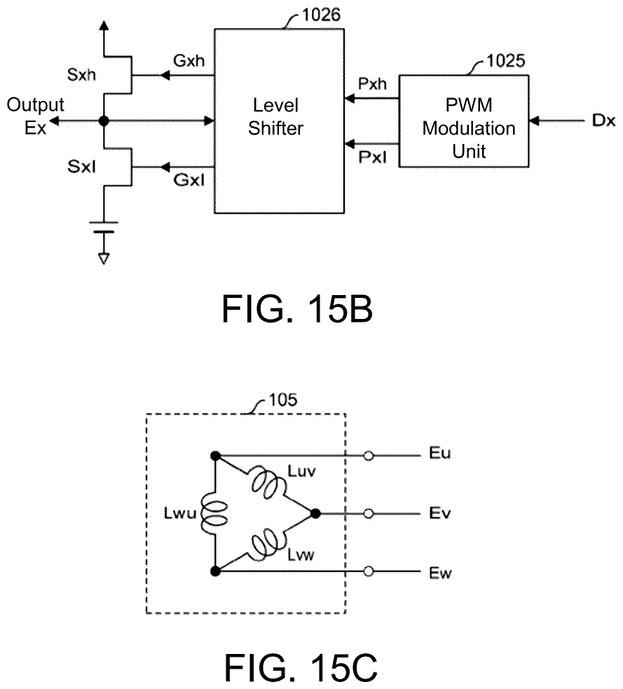

The above assumes that the coils Lu, Lv, and Lw in the motor 105 are star-connected, as shown in FIG. 15A. As shown in FIG. 15A, the voltage at the point where the coils Lu, Lv, and Lw are connected is designated Ec. Furthermore, switching amplifiers Ampu, Ampv, and Ampw are connected to the terminals of the motor 105. As shown in FIG. 15B, the switching amplifier Ampx (where x is one of u, v, and w) includes a pair of high-side switch Sxh and low-side switch Sxl of the half-bridge group 1030, a level shifter 1026, and a PWM modulation unit 1025.

However, the embodiments of the present application are applicable not only to the star-connected motor 105 shown in FIG. 15A but also to a motor in which the coils Luv, Lvw, and Lwu are delta-connected (diagonally connected), as shown in FIG. 15C.

While star and delta connections differ in the way the terminals and coils of the motor 105 are connected, star and delta connections are equivalent to each other. By matching the parameter values (such as L and R) of each coil, the voltage, current, and operation of a delta-connected motor 105 as viewed from the switching amplifier Ampx are all equivalent to those of a star-connected motor 105.

Furthermore, while the above description focuses on a three-phase motor 105, this configuration is also applicable to motors with two or more phases.

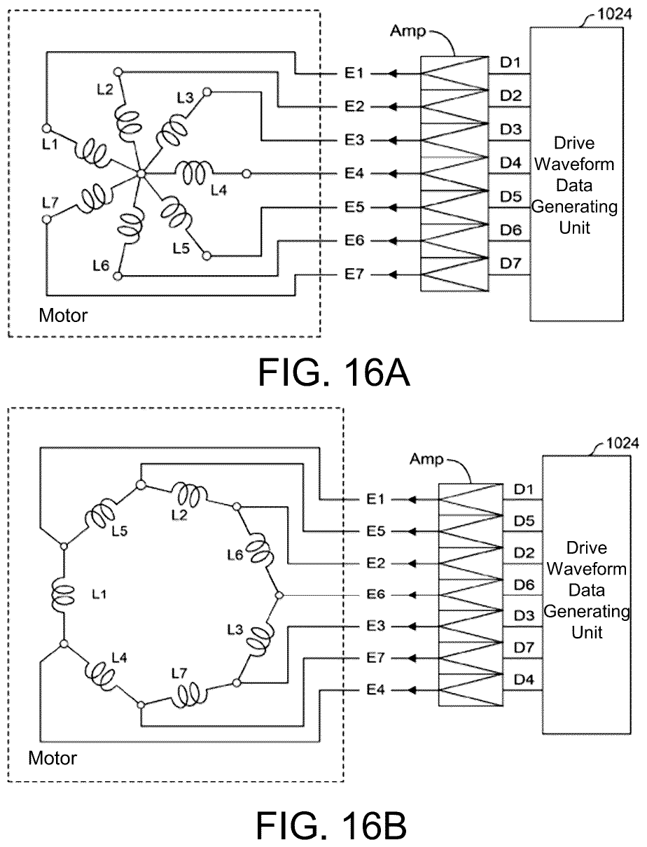

For example, FIGS. 16A and 16B show configuration examples for a seven-phase motor. FIG. 16A shows an example of a motor with star-connected coils, and FIG. 16B shows an example of a motor with delta-connected coils. The embodiments of the present application are also applicable to such motors.

Note that voltages with phases that differ by 360°/7 are supplied between both ends of each coil, in the order of coils L1 to L7. The drive voltage waveform at this time (actually PWM switching drive) is such that voltages with phases that differ by 360°/7 are outputted in the order of outputs E1 to E7 of the switching amplifier.

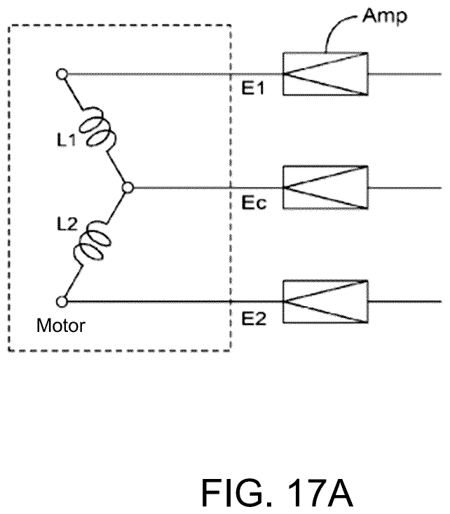

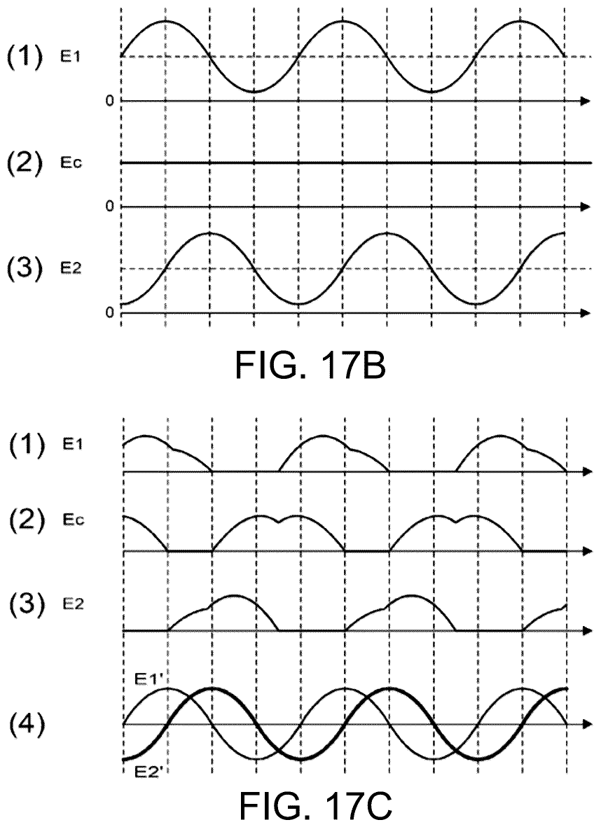

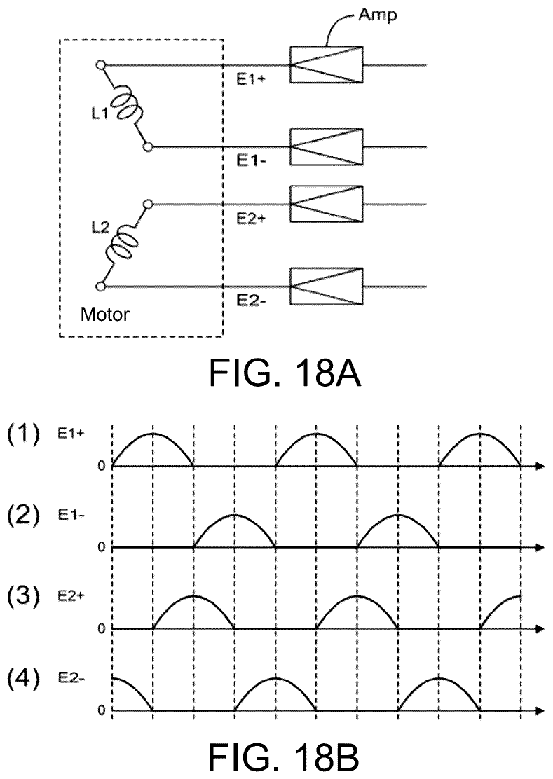

FIGS. 17A to 17C, 18A, and 18B show examples of a two-phase motor configuration and drive waveforms. Although the motor is two-phase, it is actually four-phase as it generates a rotating magnetic field, and is driven by a cosine waveform and a sine waveform with a 90° phase difference.

FIG. 17A shows an example configuration in which a two-phase motor is connected with three wires and driven by three switching amplifiers (Amp) (an example of a two-phase, three-wire, three-amplifier connection). A common wire C is connected to the connection point between the two coils L1 and L2, and a cosine waveform is generated by the potential difference between voltages E1 and Ec supplied to the other end of coil L1, and a sine wave is generated by the potential difference between voltages E2 and Ec supplied to the other end of coil L2.

In FIG. 17B, (1) represents the waveform of voltage E1, (2) represents the waveform of voltage Ec, and (3) represents the waveform of voltage E2. In this example, voltage Ec is driven at a midpoint potential (fixed duty ratio of 50%), and voltages E1 and E2 are driven by cosine and sine waves centered on voltage Ec, respectively.

FIG. 17C shows other drive waveform examples. (1) represents the waveform of voltage E1, (2) represents the waveform of voltage Ec, (3) represents the waveform of voltage E2, and (4) represents the waveforms of voltages E1′ and E2′ actually applied to each coil. The lowest potential among voltages E1, Ec, and E2 in FIG. 17B is shifted and fixed to Gnd, thereby achieving the same relative potential difference as in FIG. 17B, i.e., cosine and sine waves applied across each coil. More specifically, E1′ =E1-Ec, E2′ =E2-Ec, resulting in cosine and sine waves as shown in (4).

FIGS. 18A and 18B also show an example of configuration (a two-phase, four-wire, four-amplifier connection) and drive waveforms for a two-phase motor connected with four wires and driven by four switching amplifiers Amp.

As shown in FIG. 18A, voltage E1+ is applied to one end of coil L1, and voltage E1− is applied to the other end of coil L1. Voltage E2+ is applied to one end of coil L2, and voltage E2− is applied to the other end of coil L2.

As a result, a cosine waveform is supplied to coil L1 due to the potential difference between voltages E1+and E1−, and a sine waveform is supplied to coil L2 due to the potential difference between voltages E2+and E2−.

In FIG. 18B, (1) represents the waveform of voltage E1+, (2) represents the waveform of voltage E1−, (3) represents the waveform of voltage E2+, and (4) represents the waveform of voltage E2−. In FIG. 18B, the lowest potential at both ends of each coil is fixed to ground, and the two-wire modulated four-wire drive is used. The potential differences between the terminals of each coil are (E1+)-(E1−) and (E2+)-(E2−), which are cosine and sine waves, respectively, and are sine waves with a 90°phase difference.

Embodiments of the present application can also be applied to such two-phase motors.

### [Negative Ground and Positive Ground]

The above-described embodiments have been described using a negative ground as an example, but the embodiments of the present application can also be applied to a positive ground.

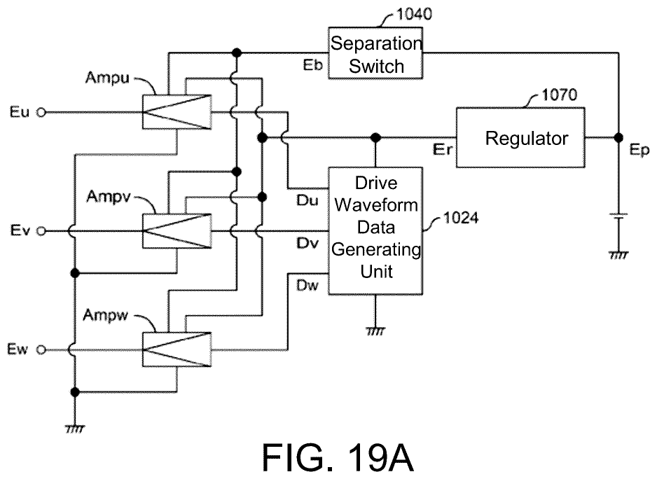

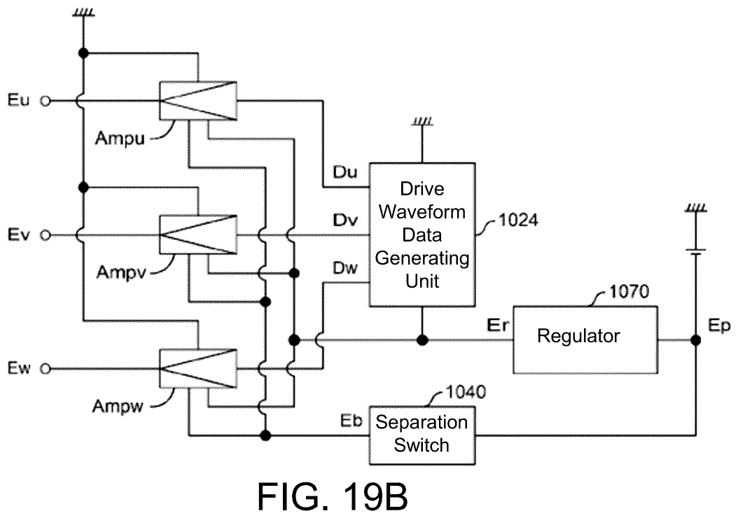

As shown generally in FIG. 19A, a negative ground is a connection configuration in which the negative side of the battery in the battery pack 101 is grounded, and the voltage Eb of the separation switch 1040 on the half-bridge group 1030 side is a positive voltage. Note that the drive waveform data generating unit 1024 and the switching amplifier Amp are also powered by the battery, and a regulator 1070 is provided for this purpose. In this case, the current condition in step S9 of FIG. 7 is that the current flowing to each coil included in the motor 105 is positive or zero. The same applies to the current condition for opening the separation switch 1040 in step S7.

On the other hand, as shown in FIG. 19B, a positive ground connection is one in which the positive side of the battery in the battery pack 101 is grounded, and the voltage Eb of the separation switch 1040 on the half-bridge group 1030 side is negative. In this case, the current condition in step S9 of FIG. 7 is that the current flowing to each coil included in the motor 105 is negative or zero. The same applies to the current condition for opening the separation switch 1040 in step S7.

In other words, while the current flows in opposite directions for negative ground and positive ground under the current conditions described above, from the perspective of power, both conditions require that the power flowing (i.e., supplied) to each coil included in the motor 105 is positive or zero. That is, the condition is that the current flows in the direction that consumes power from the power source, or the current is zero.

### [Other Technical Matters]

In the above-described embodiments, the separation switch 1040 and the switches included in the half-bridge group 1030 are shown as N-channel FETs. However, a combination of N-channel and P-channel FETs may also be used. Furthermore, the elements are not limited to conventional MOSFETs (Metal-Oxide-Semiconductor FETs), but bipolar transistors, IGBTs (Insulated Gate Bipolar Transistors), and other elements may also be used.

Furthermore, a half bridge of each phase may be configured by connecting multiple half bridges in parallel.

Furthermore, while the above example illustrates two-wire modulated three-phase sine wave continuous conduction drive, three-wire modulated drive, intermittent drive, and other methods may also be used.

Furthermore, while PWM modulation has been described as an example, other modulation methods, such as PDM (Pulse Density Modulation), PFM (Pulse Frequency Modulation), and PNM (Pulse Number Modulation), may also be used as long as the average duty ratios of the high and low frequencies are the same.

Furthermore, the diodes shown above as parasitic diodes may not necessarily be parasitic diodes, but may be diodes connected in parallel to reinforce the parasitic diodes. Even in switching elements without parasitic diodes, the diodes shown above may be bypass diodes intentionally inserted to protect the device from surges generated by the coils of the motor 105 during normal driving switching.

Furthermore, the separation switch 1040 was assumed to at least cut off current from the motor 105 to the battery of the battery pack 101 when opened, but it may also be a type that cuts off current from the battery to the motor 105 when opened.

Note that while the above example illustrates an embodiment implemented in the electrically assisted bicycle 1 as an example of an electrically assisted vehicle, the present invention is not limited to electrically assisted vehicles. It may also be applied to vehicles requiring a wide rotational speed range of a brushless motor and loss-free coasting without a clutch mechanism. Examples include vehicles such as electric motorcycles, electric kick scooters, electric automobiles (including hybrids), and trains, as well as transportation devices such as electric propeller airplanes and electric boats (e.g., those driven by screws, Voith-Schneider propellers, etc.). In some cases, it may also be used to turn off a wind power generating unit (a motor used in regenerative mode) in strong winds (e.g., when excessive rotation occurs even with the propeller pitch being set to maximum).

The above-described embodiments can be summarized as follows.

A motor control device according to an embodiment of the present application includes: (A) a drive unit including three or more half bridges for driving a brushless motor with two or more phases; (B) a separation switch that opens to cut off current flowing in at least the regenerative direction between the drive unit and a power source; and (C) a control unit configured to execute the following steps when an event that requires the brushless motor to be turned off is detected: a first step of setting a drive output of at least some of the three or more half bridges to ground level or turning it off; a second step of opening the separation switch; and
a third step of turning off a drive output of the remaining half bridges among the three or more half bridges whose drive output is not turned off during a period when the power flowing to a coil included in the brushless motor is positive or zero.

This control enables the brushless motor to be safely turned off. Note that the second and third steps may be executed simultaneously if the respective power conditions are met simultaneously. Furthermore, if multiple phases meet the power conditions in the third step, the drive outputs may be turned off simultaneously. This embodiment can be applied not only to motor off at overspeed but also to motor off at normal speed.

The first step described above may also be a step of setting drive outputs of all three or more half bridges to ground level. This allows for a more flexible timing for executing the second step, making implementation easier.

The control unit described above may also include (c1) a drive waveform data generating unit that generates a drive waveform for each of the three or more half bridges, and (c2) a switching signal generating unit that generates a switching signal for each switching element included in the three or more half bridges based on the generated drive waveform. In this case, the control unit described above zeros the amplitude of the drive waveforms (e.g., drive waveforms for at least some half bridges) in the first step. As a result, the drive outputs are set to ground level.

Furthermore, the control unit described above may include a drive output control unit that controls, for each of the three or more half bridges, a switching signal outputted to each switching element included in the three or more half bridges to cause the switching element that receives the switching signal to open. By incorporating such a drive output control unit, the drive output can be turned off at an appropriate timing in or before the third step by opening the high-side switching element (or, in some cases, a pair of switching elements) and the low-side switching element (or, in some cases, a pair of switching elements) for each half bridge.

Furthermore, in the second step, the control unit described above may open the separation switch during a period when power flowing from the power supply side to the drive unit side via the separation switch is positive or zero. For example, if not all drive outputs of the three or more half bridges are set to ground level, opening the separation switch when such a power condition is met allows the brushless motor to be safely turned off.

Furthermore, in the second step, the control unit described above may detect the current flowing through the separation switch and open the separation switch during a period when power flowing from the power supply side to the drive unit side via the separation switch is positive or zero. If the current flowing through the separation switch or a current substantially equivalent to it can be detected, such a mechanism can be utilized to safely turn off the brushless motor.

On the other hand, in the second step, the control unit described above may estimate a period during which power flowing from the power supply side to the drive unit side via the separation switch is positive or zero based on rotational phase information of the brushless motor, and open the separation switch accordingly. For example, even if the current flowing through the separation switch or a current substantially equivalent to it cannot be detected, the rotational phase information of the brushless motor (e.g., a Hall signal) may sometimes identify the timing or period that satisfies the power conditions, and this information may be used.

Furthermore, in the third step, the control unit described above may sequentially turn off drive outputs of half bridges of the three or more half bridges whose drive outputs are not turned off during a period when the power flowing to a coil of the brushless motor is positive or zero. The drive outputs may be turned off sequentially, or simultaneously as long as certain conditions are met.

Furthermore, in the third step, the control unit described above may detect the current flowing through each drive output of the three or more half bridges and determine the timing to turn off the drive outputs of half bridges of the three or more half bridges whose drive outputs are not turned off during a period when the power flowing to a coil of the brushless motor is positive or zero. If the current flowing through the coils of the brushless motor can be detected, utilizing such a mechanism allows the brushless motor to be safely turned off.

In the third step, the control unit described above may estimate a period during which power flowing to a coil included in the brushless motor is positive or zero based on the rotational phase information of the brushless motor, and determine a timing to turn off the drive output of half bridges of the three or more half bridges whose drive output are not turned off. The rotational phase information of the brushless motor (e.g., Hall signals) may identify the timing and period that satisfies the power conditions, and this information is used.

In addition, before the first step, the control unit described above may control, prior to the first step, an output torque of the brushless motor to gradually approach zero by changing at least one of a duty ratio and a lead angle in the switching of the three or more half bridges. This can reduce shocks and the like when turning off the brushless motor.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A motor control device comprising:
a drive unit including three or more half bridges for driving a brushless motor with two or more phases;
a separation switch that opens to cut off current flowing in at least a regenerative direction between the drive unit and a power source; and
a control unit configured to execute the following steps when an event that requires the brushless motor to be turned off is detected:
a first step of setting a drive output of at least some of the three or more half bridges to ground level or turning off said at least some of the three or more half bridges;
a second step of opening the separation switch; and
a third step of turning off a drive output of the remaining half bridges of the three or more half bridges whose drive outputs are not turned off during a period when power flowing to a coil included in the brushless motor is positive or zero.

2. The motor control device according to claim 1, wherein the first step is a step of setting drive outputs of all of the three or more half bridges to ground level.

3. The motor control device according to claim 2,
wherein the control unit includes:
a drive waveform data generating unit that generates a drive waveform for each of the three or more half bridges; and
a switching signal generating unit that generates a switching signal for each switching element included in the three or more half bridges based on the generated drive waveform, and
wherein the control unit sets an amplitude of the drive waveform to zero in the first step.

4. The motor control device according to claim 1, wherein the control unit includes a drive output control unit that controls, for each of the three or more half bridges, a switching signal outputted to each switching element included in the half bridges to cause the switching element that receives the switching signal to open.

5. The motor control device according to claim 1, wherein in the second step, the control unit opens the separation switch during a period when power flowing from the power supply side to the drive unit side via the separation switch is positive or zero.

6. The motor control device according to claim 1, wherein in the second step, the control unit detects current flowing through the separation switch and opens the separation switch during a period when power flowing from the power supply side to the drive unit side via the separation switch is positive or zero.

7. The motor control device according to claim 1, wherein in the second step, the control unit estimates a period during which power flowing from the power supply side to the drive unit side via the separation switch is positive or zero based on rotational phase information of the brushless motor, and opens the separation switch accordingly.

8. The motor control device according to claim 1, wherein in the third step, the control unit sequentially turns off drive outputs of half bridges of the three or more half bridges whose drive outputs are not turned off during a period when power flowing to a coil included in the brushless motor is positive or zero.

9. The motor control device according to claim 1, wherein in the third step, the control unit detects current that flows through each drive output of the three or more half bridge, and determines a timing to turn off drive outputs of half bridges of the three or more half bridges whose drive outputs are not turned off during a period when power flowing to a coil included in the brushless motor is positive or zero.

10. The motor control device according to claim 1, wherein in the third step, the control unit estimates a period during which power flowing to a coil included in the brushless motor is positive or zero based on rotational phase information of the brushless motor, and determines a timing to turn off drive outputs of half bridges of the three or more half bridges whose drive outputs are not turned off.

11. The motor control device according to claim 1, wherein the control unit controls, prior to the first step, an output torque of the brushless motor to gradually approach zero by changing at least one of a duty ratio and a lead angle in switching of the three or more half bridges.

12. A transportation device comprising the motor control device according to claim 1.
